(19) United States
(12) Patent Application Publication
(10) Pub. No.: US 2026/0203695 A1
(43) Pub. Date: Jul. 16, 2026

(54) SYSTEMS AND METHODS FOR REVENUE INTELLIGENT DIGITAL ASSISTANT USING REAL-TIME DATA MESH

(71) Applicant: Ingram Micro Inc., Irvine, CA (US)

(72) Inventor: Sanjib SAHOO, Naperville, IL (US)

(21) Appl. No.: 19/560,331

(22) Filed: Mar. 9, 2026

Related U.S. Application Data
(63) Continuation-in-part of application No. 18/341,714, filed on Jun. 26, 2023.
(63) Continuation-in-part of application No. 18/349,836, filed on Jul. 10, 2023.

(51) Int. Cl. G06Q 10/0637

(52) U.S. Cl. CPC G06Q 10/0637

(57) ABSTRACT

Systems and methods provide a revenue intelligent digital assistant (R-IDA) for proactive opportunity generation in distribution ecosystems. A real-time data mesh (RTDM) with change data capture (CDC) monitors transactional systems, transforms data for consistency, allocates to purposive datastores (PDSes) in a Global Data Lake, and enables federated parallel queries. The R-IDA derives revenue attributes, processes via predictive models, and generates/gates opportunities (e.g., hot/follow-up) for delivery, improving profitability. Feedback refines models; applicable across industries.

### CROSS-REFERENCE TO RELATED APPLICATIONS

This application is a Continuation-in-Part (CIP) of U.S. patent application Ser. No. 18/341,714, filed on Jun. 26, 2023 and is a Continuation-in-Part (CIP) of U.S. patent application Ser. No. 18/349,836, filed on Jul. 10, 2023. The disclosure of each application is hereby incorporated by reference in their entireties into the present application.

### BACKGROUND

The traditional global distribution industry faces challenges in revenue generation, including reactive fulfillment models, inefficiencies in opportunity identification, and limited use of real-time data for proactive selling. Traditionally, distributors respond to customer inquiries rather than anticipating needs, leading to missed revenue opportunities. Inventory, quoting, pricing, and renewal data are often siloed across disparate systems, such as Enterprise Resource Planning (ERP) systems, hindering timely insights. Compliance, SKU management, and evolving consumer expectations further complicate revenue optimization.

In complex distribution ecosystems, managing revenue opportunities requires real-time visibility into transactional data. However, traditional systems suffer from data fragmentation, inconsistency, and delayed processing. Data from ERPs, quoting systems, and other sources is often incompatible, leading to silos that prevent holistic analysis. Inefficient data capture and integration limit the ability to generate proactive signals for sales teams, reducing quote conversion rates, engagement value, and overall profitability.

Despite these challenges, distribution models offer advantages, such as enabling manufacturers to focus on core competencies while leveraging distributors'reach. To realize these benefits, systems must evolve to incorporate real-time data meshes for proactive revenue intelligence. Systems described herein address these issues by integrating real-time data capture, purposive storage, and predictive modeling to generate actionable revenue opportunities.

### BRIEF SUMMARY OF THE INVENTION

The disclosed embodiments relate to aspects of a revenue intelligent digital assistant method and system that encompass distribution management, supply chain management, and related functionalities. The global distribution industry grapples with challenges in revenue management, including reactive models and data silos. These necessitate innovative solutions for proactive opportunity generation. Key hurdles include inefficient data integration from ERPs and other systems, inconsistent formats, and limited real-time analytics for identifying revenue signals.

A quintessential problem is the lack of proactive demand signals. Distributors traditionally fulfill orders reactively, missing opportunities to drive profitability through targeted engagements. Navigating compliance, localization, and SKU data adds complexity. Consumer shifts toward ecosystem commerce demand efficient, data-driven platforms. Despite challenges, distribution enables focus on core competencies and value-added services. For sustainability, processes must streamline revenue identification using real-time data.

Disclosed systems, methods, and non-transitory computer-readable media provide a revenue intelligent digital assistant (R-IDA) configured to generate proactive revenue opportunities within a distribution ecosystem. Conventional distribution platforms are technically constrained by reactive fulfillment architectures, batch-oriented analytics, and fragmented data pipelines that prevent timely detection of revenue signals. These limitations arise from heterogeneous transactional systems, inconsistent data schemas, delayed synchronization, and centralized storage models that inhibit parallel computation and low-latency analysis.

In some embodiments, the disclosed R-IDA addresses these technical limitations by employing a real-time data mesh (RTDM) that continuously monitors a plurality of transactional systems using change data capture (CDC), including log-based capture, trigger-based capture, or polling-based capture. This event-driven capture mechanism enables near-real-time propagation of transactional changes from enterprise resource planning systems, quoting systems, pricing systems, ordering systems, subscription management systems, and billing systems. A technical advantage of this approach is the elimination of batch latency and stale data artifacts, allowing revenue signals to be detected prior to customer-initiated engagement.

In some embodiments, captured data changes are processed through a transformation module that performs schema adaptation, normalization, and enrichment to produce standardized representations suitable for downstream analytics. In contrast to point-to-point integrations, this transformation pipeline decouples source system semantics from analytical consumption, reducing integration fragility and enabling uniform attribute derivation across heterogeneous systems. This improves computational consistency and reduces error propagation caused by schema drift.

In some embodiments, transformed data is allocated into a storage layer comprising a plurality of purposive datastores (PDSes) dynamically provisioned within a Global Data Lake. Each PDS can be configured based on data classification, access frequency, or computational workload, such as quoting data, pricing data, customer behavior data, order history data, renewal data, or vendor data. A technical advantage of this purposive storage architecture is that it avoids monolithic data models, reduces query contention, improves cache locality, and enables independent scaling of analytical workloads.

In some embodiments, a federated data processing layer integrates data across the plurality of PDSes and enables parallel query execution without requiring centralized materialization. In some non-limiting examples, federated queries can join customer, product, quote, order, and subscription data using shared identifiers, with fallback imputation applied when values are missing. This federated execution model provides a technical improvement over centralized warehouses by reducing data duplication, lowering latency for complex joins, and enabling real-time attribute computation across domains.

In some embodiments, the R-IDA derives a plurality of revenue-related attributes from the federated data, including historical quote behavior, open quote status, order conversion behavior, customer segmentation, temporal recency, seasonality, vendor affinity, customer size, and product or SKU traction. In some non-limiting examples, attributes are computed using rolling time windows, cohort baselines, and normalized metrics, which allows the system to distinguish transient noise from meaningful revenue signals. This attribute derivation pipeline provides higher-fidelity feature vectors than siloed analytics systems.

In some embodiments, the derived attributes are processed using one or more predictive scoring models to generate revenue opportunity scores. In some non-limiting examples, the predictive scoring models comprise an ensemble executed in parallel, including a propensity model configured to estimate conversion likelihood, a margin uplift model configured to estimate revenue impact, and a renewal prediction model configured to estimate renewal probability. Outputs of the ensemble can be combined into composite scores using weighted blending, enabling technical separation of scoring objectives and improved predictive accuracy relative to single-model approaches.

In some embodiments, proactive revenue opportunities are generated based on the revenue opportunity scores prior to receipt of a customer-initiated request. In some non-limiting examples, hot opportunities are identified based on observed traction across multiple customers, partners, or channels within defined time windows using standardized traction metrics relative to dynamic baselines, while follow-up opportunities are identified based on temporal recency of quote, order, or renewal events within rolling windows. This provides a technical mechanism for time-sensitive prioritization that adapts continuously as new data arrives.

In some embodiments, the R-IDA applies gating rules to govern whether a proactive revenue opportunity is emitted or suppressed. In some non-limiting examples, gating rules can include confidence thresholds, margin thresholds, vendor authorization conditions, or timing constraints. By separating scoring from gating, the system provides deterministic control over opportunity emission, reduces false positives, and enforces compliance requirements without degrading model performance.

In some embodiments, proactive revenue opportunities are delivered to downstream engagement interfaces, including sales dashboards, partner interfaces, customer interfaces, or mobile interfaces, via API endpoints or message topics. In some non-limiting examples, delivery includes error handling, retry mechanisms, and idempotent message handling, which improves reliability in distributed environments and ensures consistent opportunity presentation.

In some embodiments, outcomes associated with delivered opportunities are written back to the RTDM and corresponding PDSes to form a closed-loop learning system. In some non-limiting examples, outcome data is used for model retraining, drift detection, and score recalibration. This feedback architecture provides a technical advantage by enabling continuous improvement without manual rule tuning or offline reprocessing.

In some embodiments, governance controls including role-based access control and audit logging are applied across the opportunity lifecycle, enabling deployment across heterogeneous enterprise environments while maintaining traceability and compliance. Collectively, the disclosed embodiments provide a technical improvement over reactive distribution systems by transforming revenue identification into a real-time, event-driven, analytically governed capability that operates continuously across enterprise data sources using distributed computation rather than manual intervention.

### BRIEF DESCRIPTION OF THE DRAWINGS/FIGURES

FIG. 1 illustrates the data transformation and normalization process via schema adaptation, normalization, and enrichment in the Real-Time Data Mesh (RTDM), showing input from disparate transactional systems like ERPs to a standardized format for revenue attribute preparation, according to some embodiments.

FIG. 2 depicts an advanced revenue platform with interconnected modules including the R-IDA, Revenue Interaction Module, RTDM module, AI module, and others for managing revenue networks, showing data flow and integration for opportunity optimization, according to some embodiments.

FIG. 3 illustrates the RTDM module with integration layer, data layer including Global Data Lake and PDSes, AI module, data engine layer with headless engines, data distribution mechanism, and experience layer for real-time revenue data management, according to some embodiments.

FIG. 4 illustrates the R-IDA UI with Unified View Module, Real-Time Data Exchange Module, Collaborative Decision-Making Module, RBAC Module, Customization Module, Data Visualization Module, and Mobile Accessibility Module for displaying and managing revenue opportunities, according to some embodiments.

FIG. 5 illustrates the overall system architecture for the R-IDA, showing integration layer connecting to ERPs, data layer with Global Data Lake and PDSes, AI factory with ensemble models, data engine layer, output to engagement interfaces, and feedback loop, according to some embodiments.

FIG. 6 depicts the attribute derivation module with join processor using shared identifiers to combine data from PDSes like quoting and customer behavior PDSes, fallback imputation engine for handling missing data, and output of revenue attributes, according to some embodiments.

FIG. 7 shows the predictive scoring module with propensity model, margin uplift model, renewal prediction model executed in parallel, weighted blending processor for composite scores, and drift monitoring unit, according to some embodiments.

FIG. 8 illustrates the opportunity generation module with signal identifier scanning federated data, pre-request analyzer confirming proactive status, classification engine labeling types, and output of structured opportunities, according to some embodiments.

FIG. 9 depicts the hot opportunity classification module with traction calculator for velocity metrics, z-score normalizer for standardization, cohort segmenter for grouping, time window applicator, and labeled hot opportunity output, according to some embodiments.

FIG. 10 shows the follow-up opportunity classification module with recency evaluator for time decay, rolling window applicator, cohort behavior analyzer, temporal metric integrator for unified scores, and labeled follow-up output, according to some embodiments.

FIG. 11 illustrates the gating and delivery module with rule evaluator for thresholds like margin and ATP, threshold applicator, suppression handler for de-duplication, delivery dispatcher via APIs/topics with error handling, and filtered opportunity output, according to some embodiments.

FIG. 12 depicts the feedback loop module with outcome capture unit, write-back processor to PDSes, drift monitoring analyzer, retraining initiator for model updates, and refined model output, according to some embodiments.

### DETAILED DESCRIPTION OF THE INVENTION

Embodiments may be implemented in hardware, firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices, and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

It should be understood that the operations shown in the exemplary methods are not exhaustive and that other operations can be performed as well before, after, or between any of the illustrated operations. In some embodiments of the present disclosure, the operations can be performed in a different order and/or vary.

In some embodiments, the revenue intelligent digital assistant (R-IDA) comprises a decision-making layer operating on real-time, purpose-organized data to generate, rank, and deliver revenue opportunities independent of user initiation.

As used herein, “proactive” revenue opportunities refer to opportunities generated prior to receipt of a customer-initiated request or inquiry.

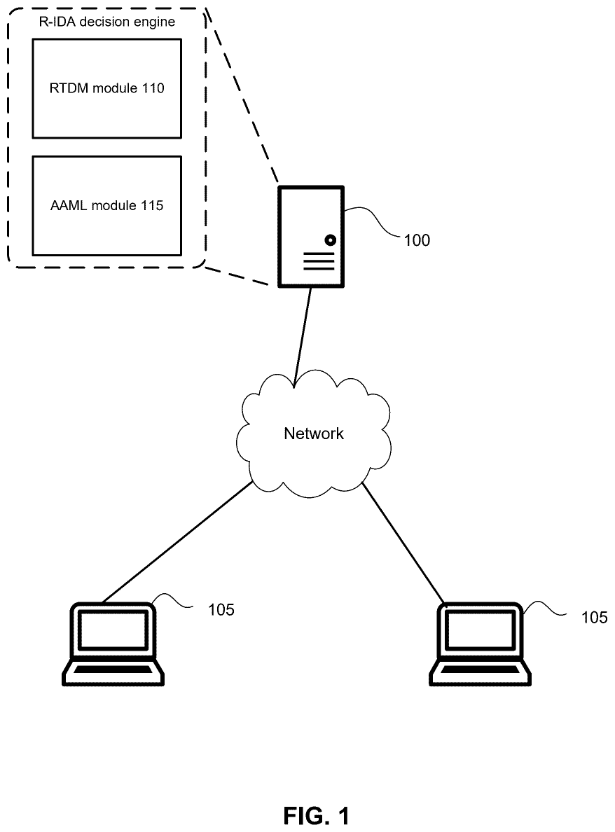

FIG. 1 illustrates a system 100 for revenue management. System 100 (FIG. 1) is a revenue management solution designed to address the challenges faced by fragmented distribution ecosystems in the global distribution industry. System 100 can include several interconnected components and modules that work in harmony to optimize revenue operations, enhance collaboration, and drive business efficiency.

The Revenue Intelligent Digital Assistant (R-IDA) 105 serves as a centralized revenue optimization interface, providing stakeholders (e.g., users 105) with a unified view of revenue opportunities. It consolidates information from various sources and presents real-time data, analytics, and functionalities tailored to the specific roles and responsibilities of users. Users 105 represent the potential end-users of the system, such as sales associates, revenue managers, or other stakeholders who interact with the R-IDA to prioritize opportunities and access real-time insights. These users may include individuals in roles focused on quote management, opportunity identification, or revenue optimization, enabling them to leverage the transformed data for proactive decision-making. By offering a customizable and intuitive dashboard-style layout, the R-IDA enables users to access relevant information and tools, empowering them to make data-driven decisions and efficiently manage their revenue activities.

For example, a sales manager can use the R-IDA to monitor quote traction, track renewal opportunities, and view real-time profitability metrics across multiple channels. They can visualize data through interactive charts and graphs, such as a graph displaying quote velocity or a bar chart showing margin uplift by customer segment. By having a unified view of revenue signals, the sales manager can identify high-potential opportunities, optimize engagements, and ensure profitable transactions.

The R-IDA 105 integrates with other modules of System 100, facilitating real-time data exchange, synchronized operations, and streamlined workflows. Through API integrations, data synchronization mechanisms, and event-driven architectures, R-IDA 105 ensures smooth information flow and enables collaborative decision-making across the revenue ecosystem.

For instance, when a proactive opportunity is generated in the R-IDA, the system automatically updates sales dashboards, triggers notifications to engagement interfaces, and initiates outreach processes. This integration enables efficient revenue pursuit, reduces missed opportunities, and enhances overall profitability visibility.

The Real-Time Data Mesh (RTDM) module 110 is another key component of System 100, responsible for ensuring the flow of data within the revenue ecosystem. It aggregates data from multiple sources, harmonizes it, and ensures its availability in real-time.

For example, in a distribution network, the RTDM module collects data from various systems, including quoting systems, pricing engines, and customer behavior trackers. It harmonizes this data by aligning formats, standardizing metrics, and reconciling any discrepancies. The harmonized data is then made available in real-time, allowing stakeholders to access accurate and up-to-date information for revenue optimization.

The RTDM module 110 can be configured to capture changes in data across multiple transactional systems in real-time. It employs a sophisticated Change Data Capture (CDC) mechanism that constantly monitors the transactional systems, detecting any updates or modifications. The CDC component is specifically designed to work with various transactional systems, including legacy ERP systems, Customer Relationship Management (CRM) systems, and other enterprise-wide systems, ensuring compatibility and flexibility for businesses operating in diverse environments.

By having access to real-time data, stakeholders can make timely decisions and respond quickly to revenue opportunities. For example, if the RTDM module detects a sudden surge in quote activity for a particular SKU, it can trigger alerts to the sales team, enabling them to capitalize on hot opportunities and prevent revenue loss.

The RTDM module 110 facilitates data management within revenue operations. It enables real-time harmonization of data from multiple sources, freeing vendors, resellers, customers, and end customers from constraints imposed by legacy ERP systems. This enhanced flexibility supports improved profitability, customer engagement, and innovation.

Another component of System 100 is the Advanced Analytics and Machine Learning (AAML) module 115. Leveraging powerful analytics tools and algorithms such as distributed computing frameworks, machine learning libraries, or stream processing engines, the AAML module extracts valuable insights from the collected data. It enables advanced analytics, predictive modeling, anomaly detection, and other machine learning capabilities.

For instance, the AAML module can analyze historical quote data to identify patterns in conversion rates and predict future opportunities. It can generate forecasts that help optimize sales cycles, ensure high-margin engagements, and minimize lost revenue. By leveraging machine learning algorithms, the AAML module automates opportunity scoring, predicts customer needs, and optimizes revenue processes.

In addition to opportunity forecasting, the AAML module can provide insights into customer behavior, enabling targeted engagements and personalized recommendations. For example, by analyzing transaction data, the module can identify cross-selling or renewal opportunities and recommend relevant actions to individual sales representatives.

Furthermore, the AAML module can analyze data from various sources, such as market trends, competitor pricing, and customer feedback, to gain a deeper understanding of revenue dynamics. This information can be used to inform strategy decisions, identify emerging opportunities, and adapt approaches to meet evolving market expectations.

System 100 emphasizes integration and interoperability to connect with existing enterprise systems such as ERP systems, warehouse management systems, and customer relationship management systems. By establishing connections and data flows between these systems, System 100 enables smooth data exchange, process automation, and end-to-end visibility across the revenue pipeline. Integration protocols, APIs, and data connectors facilitate communication and interoperability among different modules and components, creating a holistic and connected revenue ecosystem.

The implementation and deployment of System 100 can be tailored to meet specific business needs. It can be deployed as a cloud-native solution using containerization technologies and orchestration frameworks. This approach ensures scalability, easy management, and efficient updates across different environments. The implementation process involves configuring the system to align with specific revenue requirements, integrating with existing systems, and customizing the modules and components based on the business's needs and preferences.

System 100 for revenue management is a comprehensive and innovative solution that addresses the challenges faced by reactive revenue models. It combines the power of the R-IDA 105, the RTDM module 110, and the AAML module 115, along with integration with existing systems. By leveraging a diverse technology stack, scalable architecture, and robust integration capabilities, System 100 provides end-to-end visibility, data-driven decision-making, and optimized revenue operations. The examples and options provided in this description are non-limiting and can be customized to meet specific industry requirements, driving efficiency and success in revenue management.

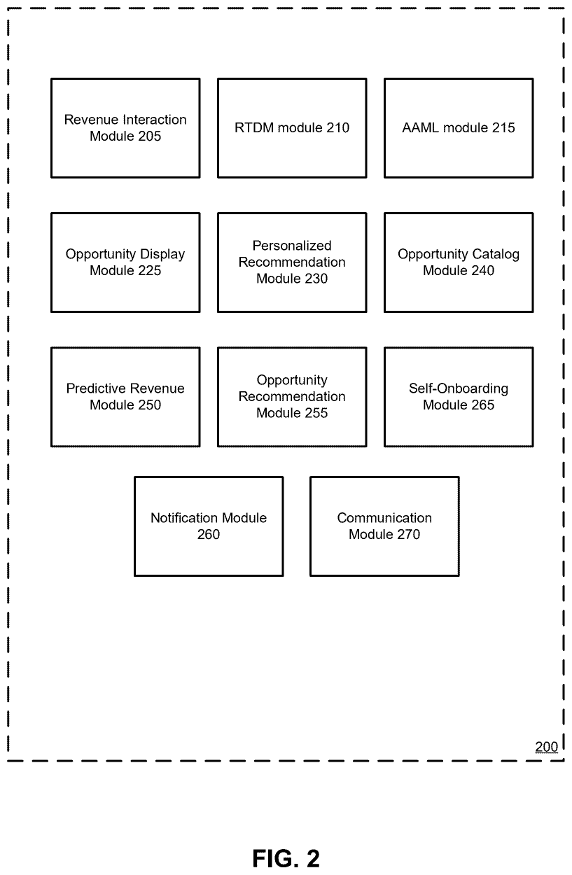

FIG. 2 illustrates an embodiment of an advanced revenue platform including System 200 for managing a distributed revenue network. System 200 can be an embodiment of System 100 and provides a modular architecture for real-time revenue opportunity generation, analytics, and engagement coordination. System 200 comprises a plurality of interoperating modules that exchange data and control signals to support event-driven revenue operations. In some embodiments, System 200 includes Revenue Interaction Module 205, RTDM module 210, AI module 215, Opportunity Display Module 225, Personalized Recommendation Module 230, Revenue Document Hub 235, Opportunity Catalog Module 240, Performance and Revenue Markers Display 245, Predictive Revenue Module 250, Opportunity Recommendation Module 255, Notification Module 260, Self-Onboarding Module 265, and Communication Module 270.

System 200, as an embodiment of System 100, is configured to integrate heterogeneous transactional data sources, perform real-time and predictive analytics, and deliver actionable revenue opportunities through governed interfaces. The modular structure of System 200 enables independent scaling, deployment, and evolution of individual modules while maintaining coordinated operation across the revenue network.

In some embodiments, a revenue intelligent digital assistant (R-IDA) is implemented across System 200 as a coordinated execution and presentation layer that provides stakeholders with a unified operational view of revenue opportunities. The R-IDA can present consolidated insights generated by the underlying modules through interactive user interfaces, enabling navigation across opportunity data, recommendations, documents, and performance indicators without requiring direct interaction with underlying transactional systems.

Revenue Interaction Module 205 is configured to manage stakeholder interactions with revenue-related entities, including customers, partners, and internal users. In some embodiments, Revenue Interaction Module 205 enforces access controls, manages session context, and mediates user-initiated actions that affect revenue workflows, thereby providing a controlled interface between users and downstream analytical and transactional components.

RTDM module 210 is configured to aggregate and propagate data across System 200 using real-time data flows. RTDM module 210 can ingest data changes from transactional systems using Change Data Capture (CDC) mechanisms, including log-based capture, trigger-based capture, or polling-based capture. In some embodiments, RTDM module 210 performs stream processing to normalize event streams, maintain temporal ordering, and provide low-latency data availability to downstream modules, enabling revenue signals to be processed shortly after occurrence.

AI module 215 is configured to perform analytical processing and machine learning operations over data provided via RTDM module 210 and other system components. In some embodiments, AI module 215 executes predictive and analytical models to identify revenue-related patterns, estimate opportunity likelihoods, and generate scoring inputs for downstream recommendation and prioritization modules. This separation of analytical logic from data ingestion improves system scalability and allows model evolution without disrupting upstream data capture.

Opportunity Display Module 225 is configured to present revenue opportunities and related analytical outputs to stakeholders in a structured manner. In some embodiments, Opportunity Display Module 225 renders opportunity attributes, scores, classifications, and supporting context in interactive views, enabling users to assess opportunity relevance, urgency, and potential impact.

Personalized Recommendation Module 230 is configured to generate tailored opportunity and engagement recommendations based on revenue data, historical interactions, and analytical outputs produced by AI module 215. In some embodiments, Personalized Recommendation Module 230 adapts recommendations to stakeholder roles, prior behavior, and contextual signals, thereby improving relevance and reducing information overload.

Revenue Document Hub 235 is configured as a centralized document management component for revenue-related artifacts. In some embodiments, Revenue Document Hub 235 stores, indexes, and retrieves documents such as quotes, contracts, pricing agreements, and compliance records, and associates such documents with corresponding revenue opportunities to provide contextual access during engagement workflows.

Opportunity Catalog Module 240 is configured to maintain and distribute structured representations of available revenue opportunities. In some embodiments, Opportunity Catalog Module 240 manages opportunity definitions, attributes, and availability states, and provides updated catalog information to downstream modules to ensure consistency across user interfaces and engagement channels.

Performance and Revenue Markers Display 245 is configured to collect and present performance indicators related to revenue activities. In some embodiments, Performance and Revenue Markers Display 245 visualizes metrics derived from transactional data and analytical outputs, enabling stakeholders to monitor pipeline health, engagement effectiveness, and revenue trends in near real time.

Predictive Revenue Module 250 is configured to generate forward-looking assessments of revenue opportunities. In some embodiments, Predictive Revenue Module 250 applies predictive models to historical and real-time data to estimate opportunity outcomes, margin impact, and engagement timing, and supplies predictive signals to downstream recommendation and prioritization components.

Opportunity Recommendation Module 255 is configured to synthesize predictive outputs, contextual data, and stakeholder preferences to produce ranked opportunity recommendations. In some embodiments, Opportunity Recommendation Module 255 operates in coordination with gating and prioritization logic to ensure that recommended opportunities satisfy defined confidence, timing, and relevance criteria.

Notification Module 260 is configured to deliver event-driven notifications related to revenue opportunities and system state changes. In some embodiments, Notification Module 260 propagates alerts and updates to stakeholders through asynchronous messaging mechanisms, enabling timely awareness of opportunity status changes, follow-up requirements, or system-generated insights.

The Self-Onboarding Module 265 is configured to support controlled onboarding of new stakeholders into System 200. In some embodiments, Self-Onboarding Module 265 manages identity verification, role assignment, and initial configuration, enabling new users or partners to access appropriate system functionality with reduced administrative overhead.

The Communication Module 270 is configured to support secure communication and collaboration within System 200. In some embodiments, Communication Module 270 enables message exchange, coordination, and information sharing among stakeholders and between system components, facilitating collaborative revenue engagement workflows.

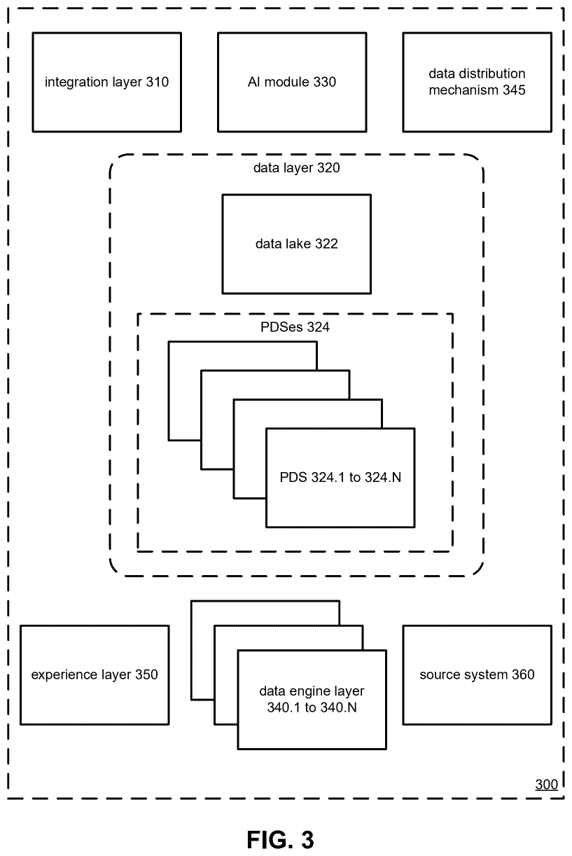

Collectively, the modules of System 200 operate in a coordinated manner to provide real-time data ingestion, analytical processing, predictive opportunity generation, governed delivery, and feedback-enabled refinement. By decoupling data capture, analytics, recommendation, and engagement functions into interoperable modules, System 200 provides improved scalability, reduced latency, and enhanced adaptability compared to monolithic revenue management systems. FIG. 3 illustrates RTDM module 300, according to an embodiment. RTDM module 300, which can be an embodiment of RTDM module 110, can include interconnected components, processes, and sub-systems configured to enable real-time data management and analysis.

The RTDM module 300, as depicted in FIG. 3, represents an effective data mesh and change capture component within the overall system architecture. The module is designed to provide real-time data management and harmonization capabilities, enabling efficient operations within the revenue and distribution management domain. For R-IDA, this ensures timely capture of revenue signals like quote updates or renewal events, supporting proactive opportunity generation.

RTDM module 300 can include an integration layer 310 (also referred to as a “system of records”) that integrates with various enterprise systems. These enterprise systems can include ERPs such as SAP, Impulse, META, and I-SCALA, among others, and other data sources like quoting platforms, pricing engines, and billing systems. Integration layer 310 can process data exchange and synchronization between RTDM module 300 and these systems. Data feeds are established to retrieve relevant information from the system of records, such as quotes, orders, renewals, customer segments, and pricing data. These feeds enable real-time data updates and ensure that the RTDM module operates with the most current and accurate data, crucial for deriving revenue attributes like historical behavior and SKU traction.

RTDM module 300 can include data layer 320 configured to process and translate data for retrieval and analysis. At the core of the data layer is the data mesh, a cloud-based infrastructure designed to provide scalable and fault-tolerant data storage capabilities. Within the data mesh, multiple Purposive Datastores (PDS) are deployed to store specific types of data, such as customer behavior data, quote history data, or renewal data. Each PDS is optimized for efficient data retrieval based on specific use cases and requirements, such as high-frequency queries for traction metrics in hot opportunities. The PDSes are configured to store specific types of data, such as customer data, product data, finance data, and more. These PDS serve as repositories for harmonized and standardized data, ensuring data consistency and integrity across the system, which is essential for accurate opportunity scoring in R-IDA.

In some embodiments, RTDM module 300 implements a data replication mechanism to capture real-time changes from multiple data sources, including transactional systems like ERPs (e.g., SAP, Impulse, META, I-SCALA). The captured data is then processed and harmonized on-the-fly, transforming it into a standardized format suitable for analysis and integration. This process ensures that the data is readily available and up-to-date within the data mesh, facilitating real-time insights and decision-making for revenue optimization, such as identifying time-sensitive follow-ups.

More specifically, data layer 320 within the RTDM module 300 can be configured as a powerful and flexible foundation for managing and processing data within the revenue ecosystem. In some embodiments, data layer 320 can encompasses a highly scalable and robust data lake, which can be referred to as data lake 322, along with a set of purposive datastores (PDSes), which can be denoted as PDSes 324.1 to 324.N. These components work in harmony to ensure efficient data management, harmonization, and real-time availability, supporting R-IDA's attribute derivation from sources like open quotes and market trends.

At the core of data layer 320 lies the data lake, data lake 322, a state-of-the-art storage and processing infrastructure designed to handle the ever-increasing volume, variety, and velocity of data generated within revenue operations. Built upon a scalable distributed file system, the data lake provides a unified and scalable platform for storing both structured and unstructured data. Leveraging the elasticity and fault-tolerance of cloud-based storage, data lake 322 can accommodate the influx of data from diverse sources, including high-velocity quote and order streams for R-IDA processing.

Associated with data lake 322, a population of purposive datastores, PDSes 324.1 to 324.N, can be employed. Each PDS 324 can function as a purpose-built repository optimized for storing and retrieving specific types of data relevant to the revenue domain. In some non-limiting examples, PDS 324.1 may be dedicated to customer data, storing information such as customer profiles, preferences, and transaction history for segmentation in opportunity models. PDS 324.2 may be focused on quote data, encompassing details about quote status, pricing, and traction metrics. These purposive datastores allow for efficient data retrieval, analysis, and processing, catering to the diverse needs of revenue stakeholders, such as quick access for z-score calculations in hot opportunities.

To ensure real-time data synchronization, data layer 320 can be configured to employ one or more sophisticated change data capture (CDC) mechanisms. These CDC mechanisms are integrated with the transactional systems, such as legacy ERPs like SAP, Impulse, META, and I-SCALA, as well as other enterprise-wide systems. CDC constantly monitors these systems for any updates, modifications, or new transactions and captures them in real-time. By capturing these changes, data layer 320 ensures that the data within the data lake 322 and PDSes 324 remains up-to-date, providing stakeholders with real-time insights into the revenue ecosystem, enabling proactive signals before customer initiation.

In some embodiments, data layer 320 can be implemented to facilitate integration with existing enterprise systems using one or more frameworks, such as .NET or Java, ensuring compatibility with a wide range of existing systems and providing flexibility for customization and extensibility. For example, data layer 320 can utilize the Java technology stack, including frameworks like Spring and Hibernate, to facilitate integration with a system of records having a population of diverse ERP systems and other enterprise-wide solutions. This can facilitate smooth data exchange, process automation, and end-to-end visibility across the revenue pipeline, supporting R-IDA's shift from reactive to proactive selling.

In terms of data processing and analytics, data layer 320 leverages the capabilities of distributed computing frameworks in some non-limiting examples. These frameworks can enable parallel processing and distributed computing across large-scale datasets stored in the data lake and PDSes. By leveraging these frameworks, revenue stakeholders can perform complex analytical tasks, apply machine learning algorithms, and derive valuable insights from the data. For instance, data layer 320 can leverage machine learning libraries to develop predictive models for opportunity forecasting, optimize margin uplift, and identify potential revenue risks, directly feeding R-IDA's ensemble scoring.

In some embodiments, data layer 320 can incorporate robust data governance and security measures. Fine-grained access control mechanisms and authentication protocols ensure that only authorized users can access and modify the data within the data lake and PDSes. Data encryption techniques, both at rest and in transit, safeguard the sensitive revenue information against unauthorized access. Additionally, data layer 320 can implement data lineage and audit trail mechanisms, allowing stakeholders to trace the origin and history of data, ensuring data integrity and compliance with regulatory requirements, which is critical for revenue audits in R-IDA operations.

In some embodiments, data layer 320 can be deployed in a cloud-native environment, leveraging containerization technologies and orchestration frameworks. This approach ensures scalability, resilience, and efficient resource allocation. For example, data layer 320 can be deployed on cloud infrastructure provided by AWS, Azure, or Google Cloud, utilizing their managed services and scalable storage options. This allows for scaling of resources based on demand, minimizing operational overhead and providing an elastic infrastructure for managing revenue data, handling peaks like renewal seasons.

Data layer 320 of RTDM module 300 can incorporate a highly scalable data lake, data lake 322, along with purpose-built PDSes, PDSes 324.1 to 324.N, and employing sophisticated CDC mechanisms, data layer 320 ensures efficient data management, harmonization, and real-time availability. The integration of diverse technology stacks, such as .NET or Java, and distributed computing frameworks enables powerful data processing, advanced analytics, and machine learning capabilities. With robust data governance and security measures, data layer 320 ensures data integrity, confidentiality, and compliance. Through its scalable infrastructure and integration with existing systems, data layer 320 empowers revenue stakeholders to make data-driven decisions, optimize operations, and drive business success in the dynamic and complex distribution environment.

RTDM module 300 can include an AI module 330 configured to implement one or more algorithms and machine learning models to analyze the stored data in data layer 320 and derive meaningful insights. In some non-limiting examples, AI module 330 can apply predictive analytics, anomaly detection, and optimization algorithms to identify patterns, trends, and potential revenue risks within the pipeline. AI module 330 can continuously learn from new data inputs and adapts its models to provide accurate and up-to-date insights. AI module 330 can generate predictions, recommendations, and alerts and publish such insights to dedicated data feeds, such as opportunity scores for hot or follow-up classifications.

Data engine layer 340 comprises a set of interconnected systems responsible for data ingestion, processing, transformation, and integration. Data engine layer 340 of RTDM module 300 can include a collection of headless engines 340.1 to 340.N that operate autonomously. These engines represent distinct functionalities within the system and can include, for example, one or more recommendation engines, insights engines, and subscription management engines. Engines 340.1 to 340.N can leverage the harmonized data stored in the data mesh to deliver specific business logic and services. Each engine is designed to be pluggable, allowing for flexibility and future expansion of the module's capabilities. Exemplary engines are shown in FIG. 3, which are not intended to be limiting. Any additional headless engine can be included in data engine layer 340 or in other exemplary layers of the disclosed system. For R-IDA, these engines process attributes for scoring, such as propensity or margin uplift models.

These systems can be configured to receive data from multiple sources, such as transactional systems, IoT devices, and external data providers. The data ingestion process involves extracting data from these sources and transforming it into a standardized format. Data processing algorithms are applied to cleanse, aggregate, and enrich the data, making it ready for further analysis and integration, supporting R-IDA's real-time opportunity generation.

Further, to facilitate integration and access to RTDM module 300, a data distribution mechanism can be employed. Data distribution mechanism 345 can be configured to include one or more APIs to facilitate distribution of data from the data mesh and engines to various endpoints, including user interfaces, micro front-ends, and external systems, enabling delivery of R-IDA opportunities to sales dashboards.

Experience layer 350 focuses on delivering an intuitive and user-friendly interface for interacting with revenue data. Experience layer 350 can include data visualization tools, interactive dashboards, and user-centric functionalities. Through this layer, users can retrieve and analyze real-time data related to various revenue metrics such as quote conversion rates, margin values, and opportunity urgency. The user experience layer supports personalized data feeds, allowing users to customize their views and receive relevant updates based on their roles and responsibilities. Users can subscribe to specific data updates, such as traction changes, pricing updates, or new opportunity notifications, tailored to their preferences and roles.

Thereby, in some embodiments, RTDM module 300 for revenue management can include an integration with a system of records and include one or more of a data layer with a data mesh and purposive datastores, an AI component, a data engine layer, and a user experience layer. These components work together to provide users with intuitive access to real-time revenue data, efficient data processing and analysis, and integration with existing enterprise systems. The technical feeds and retrievals within the module ensure that users can retrieve relevant, up-to-date information and insights to make informed decisions and optimize revenue operations. Accordingly, RTDM module 300 facilitates revenue management by providing a scalable, real-time data management solution. Its innovative architecture allows for the rich integration of disparate data sources, efficient data harmonization, and advanced analytics capabilities. The module's ability to replicate and harmonize data from diverse ERPs, while maintaining auditable and repeatable transactions, provides a distinct advantage in enabling a unified view for vendors, resellers, customers, end customers, and other entities in a revenue system, including an IT distribution system. For R-IDA, this enables proactive selling across hardware, cloud, and subscriptions, applicable to any industry.

The R-IDA user interface is a downstream consumer of proactive revenue opportunities generated by the R-IDA and does not define the generation logic itself.

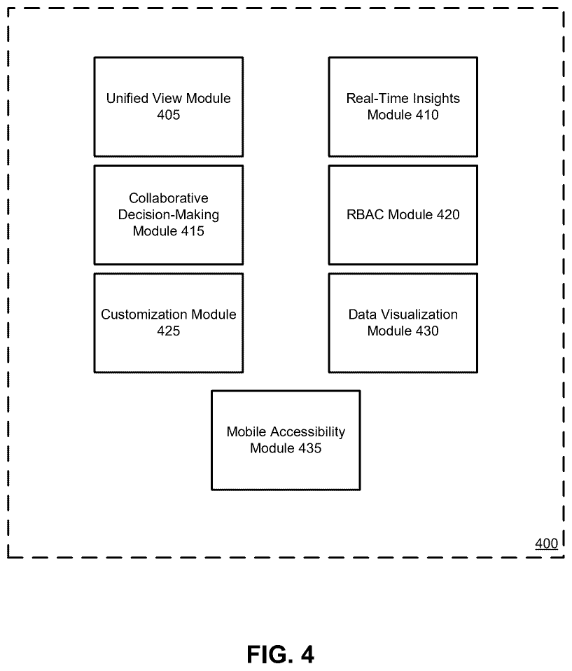

FIG. 4 illustrates R-IDA UI, according to an embodiment. R-IDA UI 400. In some embodiments, R-IDA UI 400, which can be an embodiment of R-IDA 105, represents a comprehensive and intuitive user interface designed to provide stakeholders with a unified and customizable view of the entire revenue ecosystem. It combines a range of features and functionalities that enable users to gain a comprehensive understanding of revenue opportunities and efficiently manage their operations. For R-IDA, this UI focuses on displaying proactive opportunities, such as hot quotes and follow-ups, derived from real-time data and predictive scoring.

R-IDA UI 400 can include a Unified View (UV) Module 405, which provides stakeholders with a centralized and customizable dashboard-style layout. This module allows users to access real-time data, analytics, and functionalities tailored to their specific roles and responsibilities within the revenue ecosystem. The UV Module 405 serves as a single entry point for users, offering a holistic and comprehensive view of revenue operations and empowering them to make data-driven decisions. In R-IDA, this view prioritizes ranked opportunities based on scores from propensity, margin uplift, and renewal models.

R-IDA UI 400 integrates with the Real-Time Data Exchange Module 410, to facilitate continuous exchange of data between R-IDA UI 400 and RTDM 110, to leverage one or more data sources, which can include one or more ERPs, CRMs, or other sources like quoting and billing systems. Through this module, stakeholders can access up-to-date, accurate, and harmonized data. Real-time data synchronization ensures that the information presented in R-IDA UI 400 reflects the latest insights and developments across the revenue pipeline. This integration enables stakeholders to make informed decisions based on accurate and synchronized data, such as viewing updated traction metrics for hot opportunities.

The Collaborative Decision-Making Module 415 within R-IDA UI 400 fosters real-time collaboration and communication among stakeholders. This module enables the exchange of information, initiation of workflows, and sharing of insights and recommendations. By integrating with the RTDM module 110/300, the Collaborative Decision-Making Module 415 ensures that stakeholders can collaborate effectively based on accurate and synchronized data. This promotes overall operational efficiency and collaboration within the revenue ecosystem, for example, sharing gated opportunities with sales teams for joint pursuit.

To ensure secure and controlled access to functionalities and data, R-IDA UI 400 incorporates the Role-Based Access Control (RBAC) Module 420. Administrators can define roles, assign permissions, and control user access based on their responsibilities and organizational hierarchy. The RBAC Module 420 ensures that only authorized users can access specific features and information, safeguarding data privacy, security, and compliance within the revenue ecosystem. In R-IDA, this controls visibility of sensitive attributes like customer size or margin thresholds.

The Customization Module 425 empowers users to personalize their dashboard and tailor the interface to their preferences and needs. Users can arrange widgets, charts, and data visualizations to prioritize the information most relevant to their specific roles and tasks. This module allows stakeholders to customize their view of revenue operations, providing a user-centric experience that enhances productivity and usability. For R-IDA, users can prioritize widgets for hot opportunities or renewal alerts.

R-IDA UI 400 incorporates a powerful Data Visualization Module 430, which enables stakeholders to analyze and interpret revenue data through interactive dashboards, charts, graphs, and visual representations. Leveraging advanced visualization techniques, this module presents complex data in a clear and intuitive manner. Users can gain insights into key performance indicators (KPIs), trends, patterns, and anomalies, facilitating data-driven decision-making and strategic planning. In R-IDA, visualizations include z-score traction graphs or composite score heatmaps.

R-IDA UI 400 can include Mobile and Cross-Platform Accessibility Module 435 to ensure accessibility across multiple devices and platforms. Stakeholders can access the interface from desktop computers, laptops, smartphones, and tablets, allowing them to stay connected and informed while on the go. This module optimizes the user experience for different screen sizes, resolutions, and operating systems, ensuring access to real-time data and functionalities across various devices, enabling mobile pursuit of time-sensitive follow-ups.

By integrating these reference elements/modules within R-IDA UI 400 and leveraging its integration capabilities with the RTDM module 110/300, stakeholders can benefit from a powerful and user-friendly interface for revenue management. The Unified View (UV) Module 405 provides a customizable and holistic view of the revenue environment, while the Real-Time Data Exchange Module 410 ensures accurate and up-to-date data synchronization. The Collaborative Decision-Making Module 415 promotes effective communication and collaboration, and the RBAC Module 420 ensures secure access control. The Customization Module 425, Data Visualization Module 430, and Mobile and Cross-Platform Accessibility Module 435 enhance the user experience, data analysis, and accessibility, respectively. Together, these modules enable stakeholders to make informed decisions, optimize revenue operations, and drive business efficiency within the distribution ecosystem, shifting from reactive to proactive revenue generation using R-IDA's predictive capabilities.

R-IDA 400 can incorporate high-velocity data in data-rich environments. In contemporary data-rich environments, conventional UI designs frequently grapple with presenting a large amount of information in an understandable, efficient, and visually appealing manner. The challenge intensifies when data is dynamic, changing in real-time, and needs to be displayed effectively in single-pane environments that emphasize clean, white-space-oriented designs. For R-IDA, this handles real-time updates to opportunity scores and traction metrics without clutter.

R-IDA UI 405 can be configured to manage real-time data efficiently, maintaining a visually clean interface without compromising performance. This innovative approach includes a unique configuration of the UI structure, responsive data visualizations, real-time data handling methods, adaptive information architecture, and white space optimization, optimized for displaying attributes and gated opportunities.

R-IDA UI 405 can be structured around a grid-based layout system, leveraging CSS Grid and Flexbox technologies. This structure offers the flexibility to create a fluid layout with elements that adjust automatically to the available space and content. Web-based user interface technologies such as HTML5 and CSS3 can be used to implement the UI, while JavaScript, React. js, etc., can manage the dynamic aspects of the UI, in some non-limiting examples, enabling updates for renewal predictions or follow-up alerts.

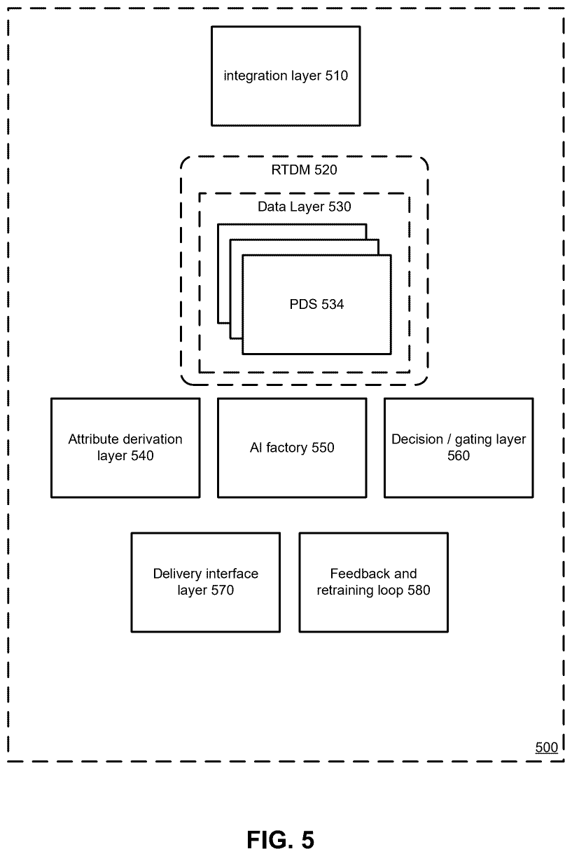

FIG. 5 illustrates a system architecture 500 for a revenue intelligent digital assistant (R-IDA) configured to generate proactive revenue opportunities using real-time data ingestion, purposive data storage, predictive modeling, rule-based gating, and governed delivery. System architecture 500 can be implemented within a distribution ecosystem and can operate across heterogeneous enterprise environments.

System architecture 500 can include an integration layer 510 configured to interface with a plurality of transactional and operational source systems. The source systems can include enterprise resource planning systems, customer relationship management systems, quoting systems, pricing systems, ordering systems, subscription management systems, billing systems, and related enterprise platforms. In some embodiments, the source systems can include backend ERP systems such as SAP and Impulse and CRM systems such as Microsoft Dynamics.

System architecture 500 can further include a real-time data mesh (RTDM) 520 operatively coupled to the integration layer 510. RTDM 520 can be configured to monitor the plurality of source systems for data changes using one or more change data capture (CDC) mechanisms. The CDC mechanisms can include log-based capture, trigger-based capture, polling-based capture, or combinations thereof. RTDM 520 can capture transactional changes and propagate such changes for downstream processing without requiring batch extraction.

System architecture 500 can include a data layer 530 coupled to RTDM 520. Data layer 530 can include a Global Data Lake 532 and a plurality of purposive datastores (PDSes) 534.1-534.N dynamically provisioned based on data domain, access pattern, or computational workload. Each PDS 534 can be configured to store a specific category of harmonized data, including but not limited to quote data, customer behavior data, customer experience data, order history data, pricing data, renewal data, inventory data, vendor data, or authorization data, as reflected in the PDS pipelines provided by the engineering materials.

RTDM 520 can be configured to transform captured data prior to allocation within data layer 530 using schema adaptation, normalization, and enrichment processes. The transformed data can be allocated to one or more PDSes 534 based on purpose and usage, enabling domain-specific retrieval without requiring centralized aggregation.

System architecture 500 can further include an attribute derivation layer 540 operatively coupled to data layer 530. Attribute derivation layer 540 can be configured to derive revenue-related attributes by joining data across multiple PDSes 534 using shared identifiers. The derived attributes can include attributes originating from the Global Data Layer, including attributes sourced from ERP systems, CRM systems, quoting systems, and customer interaction systems, and can be refreshed on a periodic basis, including daily refresh cycles.

System architecture 500 can include an AI factory 550 coupled to the attribute derivation layer 540. AI factory 550 can include a plurality of predictive models configured to evaluate the derived attributes. The predictive models can include, without limitation, a quote conversion model configured to predict a likelihood of a quote converting to an order, a customer behavior model configured to predict conversion likelihood based on search or interaction behavior, and a customer experience model configured to classify sentiment associated with reseller feedback. In some embodiments, the predictive models can be implemented using machine learning techniques including gradient-boosted decision trees and sentiment classification models and can be refreshed on a scheduled basis.

AI factory 550 can further include a model orchestration component configured to execute the predictive models in parallel and to combine model outputs into composite scores. The composite scores can represent predicted conversion likelihood, revenue impact, urgency, or other revenue-related indicators.

System architecture 500 can include a decision and gating layer 560 operatively coupled to AI factory 550. Decision and gating layer 560 can be configured to apply business rules and numeric thresholds prior to emitting a revenue opportunity. The rules can include conditions associated with quote status, recency windows, margin thresholds, inventory availability, vendor authorization, or customer experience indicators, including conditions identifying active or draft quotes, recent search activity without transaction, or unresolved negative feedback.

System architecture 500 can include a delivery interface layer 570 configured to deliver emitted revenue opportunities to one or more downstream engagement interfaces. The engagement interfaces can include sales dashboards, partner interfaces, customer interfaces, or mobile interfaces. Delivery can occur via application programming interfaces, message queues, or event topics, and can include acknowledgement, retry, and error-handling mechanisms.

System architecture 500 can further include a feedback and retraining loop 580 configured to receive outcome data associated with delivered revenue opportunities. The outcome data can include win or loss status, realized margin, engagement notes, or follow-up actions. The outcome data can be written back to one or more PDSes 534 within data layer 530 and can be used to retrain or recalibrate one or more predictive models within AI factory 550.

In operation, RTDM 520 can capture a transactional change from a source system via CDC, transform the change, allocate the transformed data to one or more PDSes 534, derive revenue-related attributes via attribute derivation layer 540, evaluate the attributes using AI factory 550, apply gating via decision and gating layer 560, deliver a proactive revenue opportunity via delivery interface layer 570, and incorporate outcome feedback via feedback and retraining loop 580.

System architecture 500 can be implemented in a cloud-native environment and can support role-based access control, audit logging, and governance mechanisms across data storage, model execution, and opportunity delivery.

The plurality of purposive datastores (PDSes) 534.1-534.N within data layer 530 can be provisioned according to specific event pipelines, as described below. In a non-limiting example, the PDS events, descriptions, and lines of business (LOB) can be enumerated as follows:
   |PDS Event|Event Description|LOB|
   |-----------|-------------------|-----|
   |6003|Impulse Availability to OST PDS |Availability |
   |6004|SAP Availability|Availability|
   |6001/6002/6101|Impulse Availability to Elastic|Availability|
   |8001|SAP Customer|Customer|
   |8003|Impulse Customer|Customer|
   |1009|Impulse End user info to Everest EU|End User|
   |3005|CMP End user|End User|
   |3003|CMP Invoice|Invoice|
   |3205|CMP Invoice Non-US|Invoice|
   |3206|CMP Invoice-India and Mexico|Invoice|
   |3207|CMP Invoice FSE(US, MX, CA)|Invoice|
   |3210|CMP Invoice PC1 to PS1 migrated Invoices|Invoice|
   |3070|CMP Order Header|Orders|
   |6020|SAP Order|Orders|
   |7030|Impulse Order Header|Orders|
   |7032|OLR Line|Orders|
   |7033|OLR Header|Orders|
   |7034|OLR Order Confirmation|Orders|
   |3071/3072|CMP Order Line|Orders|
   |7041to 7045|Impulse Order Line|Orders|
   |1002|SAP Product|Product|
   |1004|Impulse Product info to Everest VMF|Product|
   |8004|ODS On cost Product|Product|
   |7015 to 7022|Impulse Purchase Order to Elastic|Purchase Order|
   |1804 to 1807|IM 360 Quote to Elastic|Quote|
   |3002|CMP subscription|Subscription|
   |1003|SAP Vendor|Vendor|
   |1005|SAP Vendor Payment|Vendor|
   |1006|SAP Vendor Purchase|Vendor|
   |1010|Impulse Vendor Authorization|Vendor|
   |6022/6026|SAP VMF|VMF|
   |7002|Impulse Open Sales Order to Credit Engine|Orders|
   |3220|SAP Invoice to Credit Engine|Invoice|
   |3221/3222|Impulse Invoice to Credit Engine|Invoice|
   |6040|SAP Open Sales Order to Credit Engine|Orders|

The attribute derivation layer 540 derives approximately 50 revenue-related attributes, as specified in the engineering materials for the Hot Quotes (IDA) model. These attributes can be grouped into categories and are subject to ongoing revision and updates. In one embodiment, an exemplary list can include:

### General Information

country_name—Country associated with the quote.
im360_source—Source system for the quote.
revisionnumber—Revision count of the quote.
im360_subtotalamount—Subtotal value of the quote.
has_vendor_bid—Indicates if the quote has a vendor bid.
im360_creditutilization—Credit utilization percentage (only EMEA).
creditlimit—Credit limit for the account (only EMEA).
has_opportunity—Indicates if the quote is linked to an opportunity.
**Time-Based Features**
days_from_last_modified—Days since the quote was last modified.
days_from_effective_from—Days since the quote became effective.
days_till_effective_to—Days until the quote expires.

### Ownership Features

quote_owner_is_user—Quote owner is an individual user.
quote_owner_is_team—Quote owner is a team.
quote_owner_is_isr—Quote owner is an Inside Sales Representative (ISR).
account_owner_is_user—Account owner is an individual user.
account_owner_is_team—Account owner is a team.
account_owner_is_isr—Account owner is an ISR.

### Quote Activity—BCN End User

days_since_first_quote_source_bcn_end_user—Days since the first quote from this

source.
quotes_source_bcn_end_user—Number of quotes from this source.
quotes_source_invoiced_bcn_end_user—Number of invoiced quotes.
quotes_source_invoiced_perc_bcn_end_user—Percentage of quotes invoiced.
quotes_source_value_bcn_end_user—Total value of sourced quotes.
quotes_source_invoiced_revenue_bcn_end_user—Invoiced revenue from sourced quotes.
quotes_source_invoiced_value_perc_bcn_end_user—Percentage of quote value invoiced.
quotes_bcn_end_user—Total quotes for this category.
quotes_invoiced_bcn_end_user—Number of invoiced quotes.
quotes_invoiced_perc_bcn_end_user—Percentage of invoiced quotes.
quotes_value_bcn_end_user—Total value of quotes.
quotes_invoiced_revenue_bcn_end_user—Total revenue from invoiced quotes.
quotes_invoiced_value_perc_bcn_end_user—Percentage of quote value invoiced.

### Quote Activity—BCN

days_since_first_quote_source_bcn—Days since the first quote from this source.
quotes_source_bcn—Number of sourced quotes.
quotes_source_invoiced_bcn—Number of invoiced sourced quotes.
quotes_source_invoiced_perc_bcn—Percentage of invoiced sourced quotes.
quotes_source_value_bcn—Total value of sourced quotes.
quotes_source_invoiced_revenue_bcn—Revenue from invoiced sourced quotes.
quotes_source_invoiced_value_perc_bcn—Percentage of invoiced quote value.
quotes_bcn—Total number of quotes.
quotes_invoiced_bcn—Number of invoiced quotes.
quotes_invoiced_perc_bcn—Percentage of invoiced quotes.
quotes_value_bcn—Total value of quotes.
quotes_invoiced_revenue_bcn—Revenue from invoiced quotes.
quotes_invoiced_value_perc_bcn—Percentage of quote value invoiced.

### Quote Activity—Vendor

days_since_first_quote_source_vendor—Days since the first vendor quote.
quotes_source_vendor—Number of vendor-sourced quotes.
quotes_source_invoiced_vendor—Number of invoiced vendor quotes.
quotes_source_invoiced_perc_vendor—Percentage of vendor-sourced quotes invoiced.
quotes_source_value_vendor—Total value of vendor-sourced quotes.
quotes_source_invoiced_revenue_vendor—Revenue from invoiced vendor-sourced quotes.
quotes_source_invoiced_value_perc_vendor—Percentage of vendor-sourced quote value invoiced.
quotes_vendor—Total number of vendor quotes.
quotes_invoiced_vendor—Number of invoiced vendor quotes.
quotes_invoiced_perc_vendor—Percentage of vendor quotes invoiced.
quotes_value_vendor—Total value of vendor quotes.
quotes_invoiced_revenue_vendor—Total revenue from invoiced vendor quotes.
quotes_invoiced_value_perc_vendor—Percentage of vendor quote value invoiced.

### Phone Call—Derived Features

ready_to_buy_bcn_cnt—Total number of ready to buy category per bcn.
negotiating_bcn_cnt—Total number of negotiating category per bcn.
need_more_info_bcn_cnt—Total number of need more info category per bcn.
no_interest_bcn_cnt—Total number of no interest category per bcn.
already_placed_order_bcn_cnt—Total number of already placed order category per bcn.
ready_to_buy_bcn_eu_cnt—Total number of ready to buy category per bcn end user.
negotiating_bcn_eu_cnt—Total number of negotiating category per bcn end user.
need_more_info_bcn_eu_cnt—Total number of need more info category per bcn end user.
no_interest_bcn_eu_cnt—Total number of no interest category per bcn end user.
already_placed_order_bcn_eu_cnt—Total number of already placed order category per bcn end user.
ready_to_buy_vendor_cnt—Total number of ready to buy category per vendor.
negotiating_vendor_cnt—Total number of negotiating category per vendor.
need_more_info_vendor_cnt—Total number of need more info category per vendor.
no_interest_vendor_cnt—Total number of no interest category per vendor.
already_placed_order_vendor_cnt—Total number of already placed order category per vendor.
total_phonecalls_with_bcn_description—Total number of phone calls with description.
ready_to_buy_bcn_conversionperc—Percentage conversion ready to buy category per bcn.
negotiating_bcn_conversionperc—Percentage conversion negotiating category per bcn.
need_more_info_bcn_conversionperc—Percentage conversion need more info category per bcn.
no_interest_bcn_conversionperc—Percentage conversion no interest category per bcn.
already_placed_order_bcn_conversionperc—Percentage conversion already placed order category per bcn.
ready_to_buy_bcn_eu_conversionperc—Percentage conversion ready to buy category per bcn end user.
negotiating_bcn_eu_conversionperc—Percentage conversion negotiating category per bcn end user.
need_more_info_bcn_eu_conversionperc—Percentage conversion need more info category per bcn end user.
no_interest_bcn_eu_conversionperc—Percentage conversion no interest category per bcn end user.
already_placed_order_bcn_eu_conversionperc—Percentage conversion already placed order category per bcn end user.
ready_to_buy_vendor_conversionperc—Percentage conversion ready to buy category per vendor.
negotiating_vendor_conversionperc—Percentage conversion negotiating category per vendor.
need_more_info_vendor_conversionperc—Percentage conversion need more info category per vendor.
no_interest_vendor_conversionperc—Percentage conversion no interest category per vendor.
already_placed_order_vendor_conversionperc—Percentage conversion already placed order category per vendor.

In a non-limiting embodiment, the predictive models within AI factory 550, such as the quote conversion model, can utilize XGBoost as an exemplary algorithm following multiple iterations and evaluations. The target variable can be whether a quote has been invoiced (1) or not invoiced (0), predicting the likelihood of conversion into an invoice. This probability can serve as the basis for ranking and classifying quotes, for example, as Hot (predicted probability ≥50%), Medium (predicted probability ≥25%), or Low (predicted probability <25%).

For training the models, the dataset can include quotes that are no longer eligible to be ordered, such as those that have expired, have already been ordered, or have been cancelled or closed. Indirect Matching logic can be applied exclusively to the training data to infer additional Quote-to-Order (Q2O) conversions not explicitly linked, addressing gaps due to manual processes. For prediction, the dataset can comprise quotes still eligible to be ordered, determined by business rules.

In a non-limiting example, exemplary model performance metrics, including recall by country, can be as follows for the baseline model:
   |Country|Recall|
   |---------|--------|
   |IA|93%|
   |IT|67%|
   |MD|65%|
   |FT|59%|
   |MX|30%|
   |DE|58%|
   |ES|47%|
   |FR|57%|
   |UK|33%|
Additional performance tables before and after incorporating margin features are incorporated as detailed in the engineering materials, demonstrating improvements in recall values.

The decision and gating layer 560 can apply eligibility criteria for quotes to appear in the IDA/Hot Quotes list, requiring that the effective to date has not expired, the quote has not yet been ordered, and the quote status is either ‘Active’ or ‘Draft’. Draft quotes can be included due to their strong signals of conversion potential and including scenarios in which versioning behavior or system state can cause prior ordered versions to be obscured by subsequent draft versions.

In a non-limiting example, exemplary distribution of Draft versus Active quotes in Hot Quotes across countries can be as follows:
   |COUNTRY|#QUOTE|DRAFT|ACTIVE|
   |---------|---------|-------|--------|
   |IT|1,992|27%|73%|
   |FR|14,496|39%|61%|
   |IA|4,197|90%|10%|
   |MX|6,007|30%|70%|
   |DE|20,084|11%|89%|
   |FI|19,152|34%|66%|
   |MD|260,627 8% |92%|
   |UK|12,945|63%|37%|
   |ES|3,810|25%|75%|
The AI factory 550 can incorporate machine margin calculations, defined as front-end margin (Extended sales minus Extended cost), utilizing fields such as im360_averagemarginrollup for average margin and Total Margin for total margin. Approaches for integration can include adding these as features, with performance comparisons showing increases in recall (e.g., 1.7% for MD, 1.5% for UK, 0.6% for ES). In an example, correlation analysis between subtotal amount, total margin, and average margin can indicate a high correlation (e.g., 0.836) between total and average margin, but low correlation with subtotal amount.

In some embodiments, the system may further support leveraging Indirect Q2O for revenue tracking, redesigning quote ranking to incorporate quote value alongside probability, and tagging potentially ordered quotes in the hot quote list to improve data cleanliness.

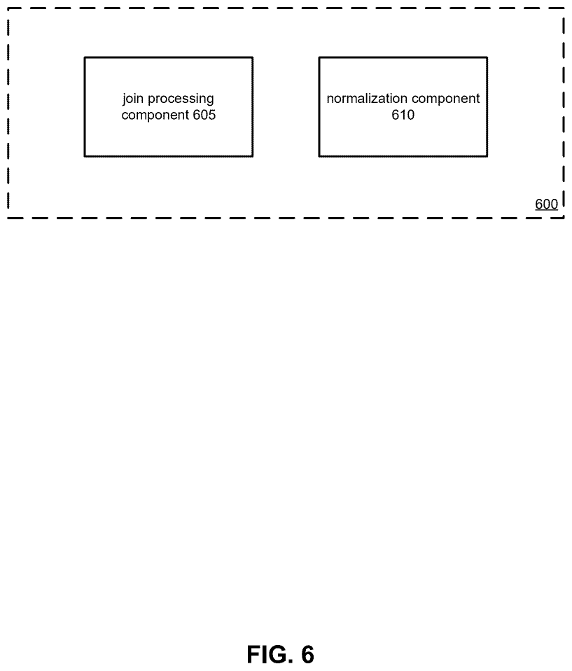

FIG. 6 illustrates an attribute derivation system 600 configured to derive revenue-related attributes from data stored in the plurality of purposive datastores (PDSes) 534.1-534.N described in connection with FIG. 5. Attribute derivation system 600 can operate as an intermediate processing layer within the revenue intelligent digital assistant (R-IDA) architecture and can transform harmonized transactional and behavioral data into structured attribute sets suitable for downstream predictive evaluation.

Attribute derivation system 600 can include a join processor 605 configured to retrieve and combine data from multiple PDSes 534 using shared identifiers. The shared identifiers can include customer identifiers, end-user identifiers, quote identifiers, order identifiers, SKU identifiers, vendor identifiers, or combinations thereof. Join processor 605 can execute federated queries, relational joins, or other association operations across domain-specific PDSes without requiring centralized replication of the underlying data.

In operation, join processor 605 can aggregate data originating from heterogeneous pipelines, including quote pipelines, order pipelines, customer pipelines, vendor pipelines, inventory pipelines, and subscription pipelines, as enumerated in the PDS event definitions associated with FIG. 5. By joining these datasets using shared identifiers, attribute derivation system 600 can construct composite views that reflect historical behavior, current transactional state, and contextual indicators relevant to revenue opportunity assessment.

Attribute derivation system 600 can further include a fallback and imputation engine 610 operatively coupled to join processor 605. Fallback and imputation engine 610 can be configured to handle missing, incomplete, or sparsely populated data encountered during attribute derivation. The imputation engine can apply different strategies depending on attribute type, data availability, or configuration parameters, ensuring that derived attribute vectors remain complete and usable for downstream processing.

In some embodiments, fallback and imputation engine 610 can apply statistical substitution techniques, cohort-based substitution techniques, rule-based defaults, or similarity-based inference using related entities. For example, if SKU-level velocity data is unavailable for a particular quote, fallback and imputation engine 610 can substitute baseline values derived from similar SKUs, vendor cohorts, customer segments, or historical averages associated with the same line of business.

The attributes derived by attribute derivation system 600 can include attributes drawn from multiple categories, including transactional attributes, behavioral attributes, temporal attributes, pricing attributes, segmentation attributes, and market-context attributes. The total number of derived attributes can exceed fifty depending on configuration, enabled pipelines, and business requirements, and can be updated over time without structural modification to the system.

Non-limiting examples of derived attributes can include quote revision counts, quote subtotal amounts, quote age and expiration intervals, historical quote-to-order conversion rates, customer interaction recency metrics, ownership indicators, vendor authorization indicators, SKU traction indicators, margin-related indicators, renewal proximity indicators, call activity indicators, and customer experience sentiment indicators, consistent with the enumerated attribute sets described in connection with FIG. 5.

Attribute derivation system 600 can operate in near real time, such that updates captured by the real-time data mesh (RTDM) 520 can trigger incremental re-derivation of affected attributes. In some embodiments, derivation can be limited to attributes associated with changed entities, enabling efficient processing without recomputing the full attribute set for all records.

In a non-limiting example, to derive SKU traction attributes for revenue opportunities, join processor 605 can combine quote velocity data from a quoting PDS with historical performance data from customer and order PDSes using SKU identifiers. If historical performance data is incomplete, fallback and imputation engine 610 can apply cohort-based substitution using SKUs associated with similar vendors, customer segments, or pricing bands.

Attribute derivation system 600 can be implemented using distributed query engines, stream processing frameworks, or microservice-based execution architectures, enabling scalable and low-latency derivation across large datasets and heterogeneous enterprise environments. These implementations can support parallel execution, fault tolerance, and dynamic scaling.

Derived attribute sets generated by attribute derivation system 600 can be cached, persisted, or written back to one or more PDSes 534 for reuse, and can be provided as structured inputs to the AI factory 550 described in FIG. 5. The attribute sets can be formatted according to model-specific schemas or standardized interfaces.

Access control and governance policies applicable to source data can propagate to derived attributes, such that sensitive attributes remain protected in accordance with role-based access control, audit logging, and compliance requirements.

In some embodiments, attribute derivation system 600 can incorporate external data sources accessed via application programming interfaces, enabling enrichment of derived attributes with market signals, pricing benchmarks, or external context when configured.

Accordingly, FIG. 6 illustrates an attribute derivation system 600 that can generate consistent, comprehensive, and governance-aware attribute sets, enabling the R-IDA architecture to support proactive revenue opportunity evaluation as described herein.

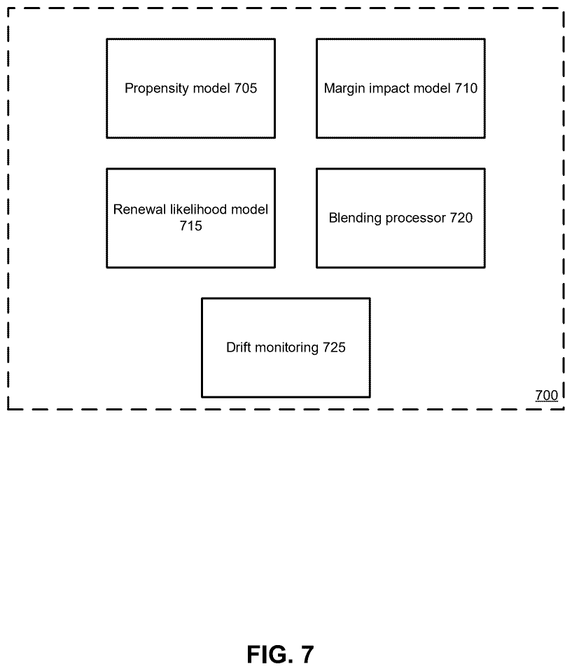

FIG. 7 illustrates a predictive scoring system 700 configured to evaluate derived attribute sets produced by the attribute derivation system 600 of FIG. 6 and to generate composite revenue opportunity scores within the revenue intelligent digital assistant (R-IDA) architecture described in FIG. 5. Predictive scoring system 700 can operate as an AI factory layer that executes a plurality of predictive models in parallel and combines their outputs to support proactive opportunity identification.

Predictive scoring system 700 can be operatively coupled to the attribute derivation system 600 and can receive structured attribute vectors corresponding to quotes, customers, orders, subscriptions, or other revenue-relevant entities. The attribute vectors can include transactional attributes, behavioral attributes, temporal attributes, pricing attributes, segmentation attributes, and market-context attributes derived from the plurality of purposive datastores (PDSes) 534.1-534.N.

Predictive scoring system 700 can include a plurality of predictive model components, each configured to evaluate a subset of the derived attributes and to generate an intermediate score or classification. In non-limiting embodiments, the plurality of predictive model components can include a propensity model 705, a margin impact model 710, a renewal likelihood model 715, and additional domain-specific models enabled through configuration.

The propensity model 705 can be configured to estimate a likelihood that a candidate revenue entity, such as an open or draft quote, will convert into an order. The propensity model 705 can process attributes including historical quote activity, quote-to-order conversion rates, ownership indicators, customer interaction recency, SKU traction, and related behavioral and temporal indicators. In some embodiments, the propensity model 705 can be implemented using machine learning techniques including logistic regression, gradient-boosted decision trees, or other classification algorithms.

The margin impact model 710 can be configured to estimate a projected profitability contribution associated with a potential revenue opportunity. The margin impact model 710 can process attributes including pricing data, cost data, customer size indicators, vendor relationships, authorization status, and historical margin performance. In some embodiments, the margin impact model 710 can be implemented using regression-based techniques or other predictive approaches suitable for estimating financial impact.

The renewal likelihood model 715 can be configured to estimate the probability or timing of a subscription, contract, or agreement renewal. The renewal likelihood model 715 can process attributes including renewal window proximity, historical renewal behavior, seasonality indicators, engagement frequency, and customer experience indicators. In some embodiments, the renewal likelihood model 715 can be implemented using time-series forecasting techniques, survival analysis, or classification models.

Predictive scoring system 700 can include a model orchestration component configured to execute the plurality of predictive model components in parallel. Parallel execution can be performed using distributed computing frameworks, containerized services, or cloud-native execution environments, enabling low-latency scoring across large volumes of entities.

Predictive scoring system 700 can further include a blending processor 720 configured to combine the intermediate outputs produced by the plurality of predictive model components into a composite opportunity score. The blending processor 720 can apply configurable weighting schemes, rule-based aggregation, or ensemble techniques, including linear combinations or stacked models, to generate the composite score.

In some embodiments, the blending processor 720 can incorporate freshness or recency adjustments based on timestamps associated with derived attributes or change events captured by the real-time data mesh (RTDM) 520. These adjustments can increase or decrease the influence of individual model outputs based on data timeliness.

Predictive scoring system 700 can include a monitoring and drift management component 725 configured to evaluate ongoing model performance. The monitoring and drift management component 725 can track performance metrics, distribution shifts, or confidence degradation and can trigger retraining, recalibration, or fallback behaviors when thresholds are exceeded.

Model retraining can be performed using outcome feedback written back to the data layer 530, including win or loss indicators, realized margin, and engagement outcomes, as described in connection with FIG. 5. Retraining schedules can be periodic, event-driven, or drift-triggered depending on configuration.

In operation, predictive scoring system 700 can receive a derived attribute vector for a candidate revenue entity, execute the propensity model 705, margin impact model 710, and renewal likelihood model 715 in parallel, blend the resulting intermediate scores using blending processor 720, and output a composite score representing overall opportunity priority.

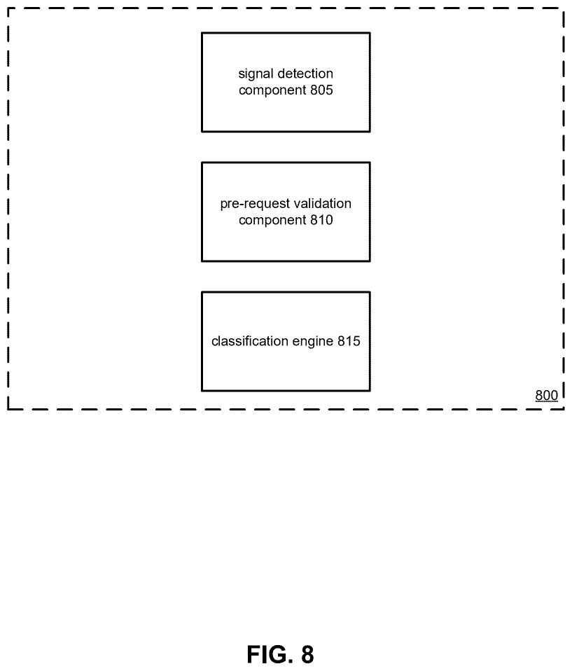

The composite opportunity score generated by predictive scoring system 700 can be used to rank, filter, or classify candidate revenue opportunities prior to application of business rules and gating logic described in FIG. 8. The composite score can represent predicted conversion likelihood, expected revenue impact, urgency, or combinations thereof.

Access to predictive scoring system 700 and its outputs can be governed by role-based access control and audit mechanisms described in FIG. 4, ensuring that model execution, score visibility, and configuration changes are controlled and traceable.

In non-limiting embodiments, additional predictive model components can be added to predictive scoring system 700 without architectural modification, enabling extensibility for channel selection, incentive optimization, credit risk assessment, or other revenue-related objectives.

Accordingly, FIG. 7 illustrates a predictive scoring system 700 that can generate robust, extensible, and governance-aware composite scores, enabling the R-IDA architecture to proactively identify and prioritize revenue opportunities across diverse enterprise environments.

FIG. 8 illustrates an opportunity generation system 800 configured to generate proactive revenue opportunities based on composite scores produced by the predictive scoring system 700 of FIG. 7 and real-time data accessed through the federated data processing layer described in FIG. 3. Opportunity generation system 800 can operate as a decision layer within the revenue intelligent digital assistant (R-IDA) architecture of FIG. 5, transforming scored and derived data into structured, actionable revenue opportunities prior to receipt of customer-initiated requests.

Opportunity generation system 800 can be operatively coupled to the real-time data mesh (RTDM) 520 and to the federated data processing layer, enabling continuous or event-driven evaluation of real-time and near-real-time data stored across the plurality of purposive datastores (PDSes). Through this coupling, opportunity generation system 800 can evaluate candidate opportunities using live transactional state, behavioral context, and temporal conditions without reliance on batch processing or explicit user queries.

Opportunity generation system 800 can include a signal identification component 805 configured to detect potential revenue-relevant signals based on evaluation of derived attributes, composite scores, and real-time data conditions. Signal identification component 805 can apply configurable rules, thresholds, or pattern detection logic to attributes such as temporal recency, renewal proximity, SKU traction, quote velocity, customer engagement frequency, or vendor authorization status.

In some embodiments, signal identification component 805 can detect renewal-related signals by identifying contracts, subscriptions, or agreements approaching configurable renewal windows, such as T-minus 30 days or T-minus 60 days, and correlating such proximity with historical renewal behavior or recent engagement indicators. In other embodiments, signal identification component 805 can detect emerging opportunity signals by identifying abnormal increases in SKU activity, quote creation frequency, or cross-customer traction within defined cohorts.

Opportunity generation system 800 can further include a pre-request validation component 810 configured to determine whether a detected signal represents a proactive opportunity rather than a response to an existing customer-initiated action. Pre-request validation component 810 can cross-reference detected signals against open quotes, active orders, recent customer requests, or historical interaction patterns stored in the PDSes to suppress reactive or redundant opportunities.

Pre-request validation component 810 can apply logic to exclude signals associated with already-engaged transactions, recently contacted customers, or completed workflows, while allowing signals associated with latent demand, underserved segments, or underutilized products to proceed. This validation ensures that generated opportunities represent anticipatory engagement rather than delayed reaction.

Opportunity generation system 800 can include a classification engine 815 configured to assign one or more classifications, priorities, or opportunity types to validated signals. Classification engine 815 can utilize composite scores from predictive scoring system 700 in combination with derived attributes and real-time context to categorize opportunities into predefined or configurable classes.

In non-limiting embodiments, classification engine 815 can assign classifications including hot opportunities associated with high traction or elevated conversion likelihood, time-sensitive follow-up opportunities associated with recency or expiration windows, renewal opportunities associated with subscription lifecycle stages, or other domain-specific opportunity types. Classification can further include assignment of priority levels, confidence indicators, and explanatory metadata.

The components of opportunity generation system 800 can operate sequentially while supporting parallel evaluation across multiple candidate entities using distributed processing frameworks. This architecture enables low-latency generation of opportunities across large populations of customers, quotes, products, or contracts in dynamic enterprise environments.

The output of opportunity generation system 800 can include a structured opportunity object comprising at least an opportunity identifier, an associated entity reference, one or more classification labels, a composite score, contextual attributes, and a rationale or explanation derived from the underlying signals and models. The structured opportunity object can be formatted for downstream gating, suppression, and delivery processing.

Opportunity generation system 800 can be configured to initiate processing in response to events propagated by the RTDM 520, including quote updates, order events, customer interactions, or subscription state changes. Event-driven invocation can be combined with periodic evaluation schedules depending on configuration and performance requirements.

In an exemplary operation, signal identification component 805 can detect increased SKU traction based on federated queries across quoting and order PDSes, pre-request validation component 810 can confirm absence of an active customer request for the identified SKU, and classification engine 815 can label the signal as a high-priority hot opportunity suitable for immediate engagement.

Opportunity generation system 800 can operate independently of product category or business model, supporting opportunity identification for hardware, software, cloud services, subscriptions, or hybrid offerings using the same architectural framework.

Governance mechanisms described in FIG. 4 can apply to opportunity generation system 800, including role-based access control, authorization checks, and audit logging, ensuring that opportunity creation and classification comply with enterprise policies and regulatory requirements.

In some embodiments, opportunity generation system 800 can include suppression and deduplication logic configured to prevent repeated generation of substantially similar opportunities within defined time windows, referencing prior opportunity records stored in the PDSes.

Classification rules, thresholds, and suppression parameters can be configurable through administrative or customization interfaces, enabling tuning by role, business unit, geography, or market conditions without modification to underlying system code.

Accordingly, FIG. 8 illustrates an opportunity generation system 800 that can transform real-time signals and predictive scores into structured, proactive revenue opportunities, forming a bridge between predictive intelligence and governed opportunity delivery within the R-IDA architecture.

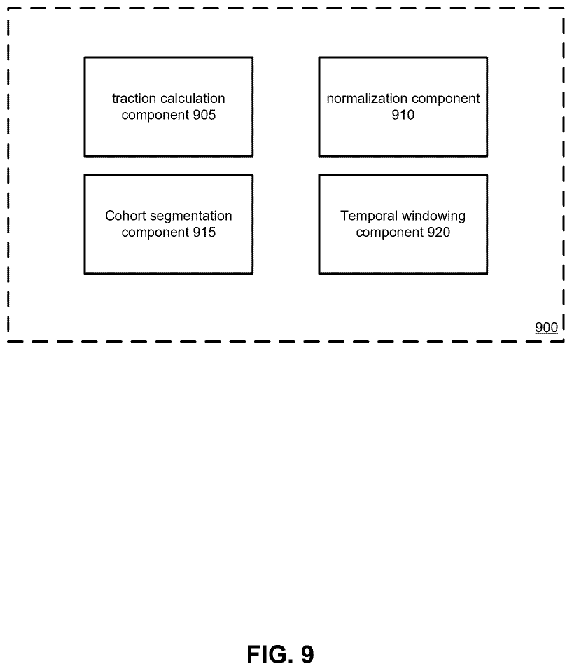

FIG. 9 illustrates a hot opportunity classification system 900 configured to identify and classify revenue opportunities exhibiting elevated traction across one or more entities within a defined temporal context. Hot opportunity classification system 900 can operate as a specialized classification component within the revenue intelligent digital assistant (R-IDA) architecture of FIG. 5 and can process candidate opportunities generated by opportunity generation system 800 of FIG. 8 using attributes derived as described in FIG. 6 and predictive scores generated as described in FIG. 7.

Hot opportunity classification system 900 can be operatively coupled to the federated data processing layer described in FIG. 3, enabling access to real-time and near-real-time data stored across the plurality of purposive datastores (PDSes). Through this coupling, system 900 can evaluate traction indicators without requiring centralized aggregation or batch processing, allowing classification decisions to reflect current market and customer behavior.

Hot opportunity classification system 900 can include a traction calculation component 905 configured to compute one or more velocity-based metrics associated with candidate opportunities. Traction calculation component 905 can evaluate, for example, the frequency, rate of change, or acceleration of quote creation, product interactions, searches, or other engagement events associated with a product, SKU, vendor, customer cohort, or channel within a configurable time window.

In some embodiments, traction calculation component 905 can compute velocity metrics by aggregating counts of relevant events across multiple customers, partners, or channels using parallel federated queries. The aggregation can be constrained by cohort definitions, geographic regions, product categories, or other segmentation criteria to ensure meaningful comparison baselines.

Hot opportunity classification system 900 can further include a normalization component 910 configured to normalize calculated traction metrics relative to historical or cohort-specific baselines. In a non-limiting embodiment, normalization component 910 can compute standardized deviation values, such as z-scores, by comparing a current velocity value to a mean and variance derived from historical observations for a corresponding cohort or entity.

Normalization component 910 can apply alternative normalization or standardization techniques in addition to or instead of z-score calculation, including percentile ranking, rolling averages, exponential smoothing, or normalized rate-of-change metrics, depending on configuration and data characteristics. Normalized outputs can be compared against configurable thresholds to identify statistically or contextually significant deviations indicative of elevated traction.

Hot opportunity classification system 900 can include a cohort segmentation component 915 configured to define and manage cohort groupings used for comparative analysis. Cohort segmentation component 915 can group entities based on attributes derived in FIG. 6, including customer size, industry, region, vendor affiliation, product category, or historical engagement patterns, ensuring that traction metrics are evaluated relative to appropriate peer groups.

Hot opportunity classification system 900 can further include a temporal windowing component 920 configured to apply rolling or fixed time windows to traction calculations. Temporal windowing component 920 can enforce recency constraints, such as trailing 24-hour, 7-day, or 30-day windows, and can apply decay functions to reduce the influence of older events, thereby emphasizing current momentum.

The components of hot opportunity classification system 900 can operate in a staged evaluation pipeline while supporting parallel execution across multiple candidate opportunities. Distributed processing frameworks described with respect to the data layer in FIG. 3 can be used to support high-volume, low-latency classification across large datasets.

The output of hot opportunity classification system 900 can include a classified opportunity object comprising at least a traction score, a normalized deviation indicator, associated cohort metadata, and one or more classification labels identifying the opportunity as a hot opportunity. This output can be provided to downstream gating and delivery components for further evaluation and action.

In an exemplary operation, traction calculation component 905 can aggregate quote velocity for a specific SKU across a defined customer cohort, normalization component 910 can compute deviation from a historical baseline for that cohort, cohort segmentation component 915 can ensure appropriate peer comparison, and temporal windowing component 920 can restrict analysis to recent activity. If the normalized traction exceeds a configured threshold, the opportunity can be classified as hot.

Hot opportunity classification system 900 can operate independently of product type or commercial model, supporting classification for physical goods, cloud services, subscriptions, or hybrid offerings using the same traction-based framework.

Governance mechanisms described in FIG. 4 can apply to hot opportunity classification system 900, including role-based access control, authorization enforcement, and audit logging of classification decisions and underlying metrics.

In some embodiments, hot opportunity classification system 900 can include suppression and deduplication logic configured to prevent repeated classification of substantially similar hot opportunities within defined temporal windows, referencing prior classification records stored in the PDSes.

Thresholds, cohort definitions, normalization techniques, and time window parameters can be configurable through administrative or customization interfaces, allowing tuning based on historical performance, market conditions, or organizational preferences.

Accordingly, FIG. 9 illustrates a hot opportunity classification system 900 that can identify momentum-driven revenue opportunities using statistically normalized traction analysis, enabling the R-IDA to prioritize high-impact engagements based on real-time market signals.

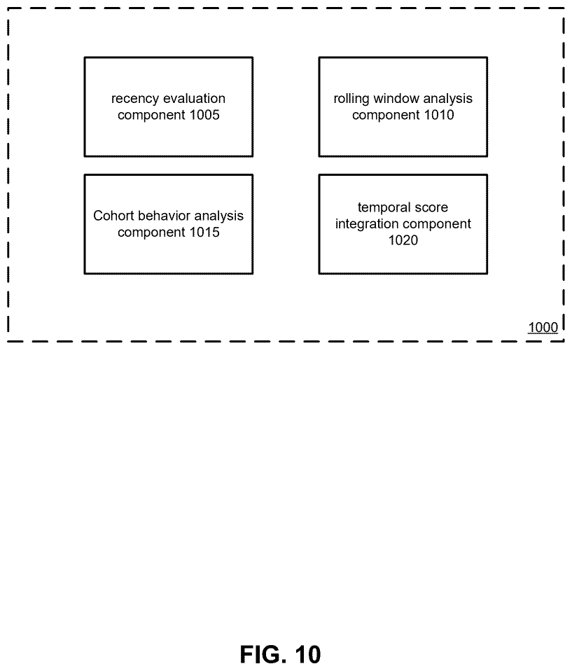

FIG. 10 illustrates a follow-up opportunity classification system 1000 configured to identify and prioritize time-sensitive revenue opportunities based on temporal recency, rolling window analysis, and cohort-based behavioral context. Follow-up opportunity classification system 1000 can operate as a specialized classification component within the revenue intelligent digital assistant (R-IDA) architecture of FIG. 5 and can process candidate opportunities generated by opportunity generation system 800 of FIG. 8 using attributes derived as described in FIG. 6 and predictive scores generated as described in FIG. 7.

Follow-up opportunity classification system 1000 can be operatively coupled to the federated data processing layer described in FIG. 3, enabling access to real-time and near-real-time temporal attributes stored across the plurality of purposive datastores (PDSes). Through this coupling, system 1000 can evaluate elapsed time since relevant events without reliance on batch processing, allowing classification decisions to reflect current engagement state.

Follow-up opportunity classification system 1000 can include a recency evaluation component 1005 configured to determine the time elapsed since one or more triggering events associated with a candidate opportunity. The triggering events can include quote creation, quote modification, customer interaction, renewal eligibility, or other time-stamped activities recorded in one or more PDSes, including quoting, ordering, or behavioral datastores.

Recency evaluation component 1005 can compute one or more recency indicators using elapsed time calculations, decay functions, or normalized temporal scores. In non-limiting embodiments, recency indicators can be derived using exponential decay, linear decay, stepwise thresholds, or other time-based functions that emphasize more recent events relative to older events.

Follow-up opportunity classification system 1000 can further include a rolling window analysis component 1010 configured to apply one or more rolling or fixed time windows to candidate opportunities. Rolling window analysis component 1010 can constrain evaluation to configurable horizons, such as the prior 24 hours, 48 hours, or other periods, and can apply weighting schemes that reduce the influence of events falling outside the defined window.

In some embodiments, rolling window analysis component 1010 can integrate temporal context such as seasonality, business cycles, or historical engagement density to adjust recency evaluations, ensuring that follow-up opportunities are identified in a manner consistent with observed temporal patterns for a given cohort or product category.

Follow-up opportunity classification system 1000 can include a cohort behavior analysis component 1015 configured to evaluate candidate opportunities relative to cohort-level behavior. Cohorts can be defined using attributes derived in FIG. 6, including customer size, industry, region, vendor alignment, or historical purchasing behavior. Cohort behavior analysis component 1015 can compare the candidate opportunity against historical outcomes or engagement patterns observed within the same or similar cohorts.

Cohort behavior analysis component 1015 can apply similarity metrics, clustering techniques, or comparative statistics to identify whether a recent event aligns with patterns historically associated with successful follow-up engagement. Opportunities exhibiting strong alignment with cohort-level success indicators can be assigned elevated follow-up relevance.

Follow-up opportunity classification system 1000 can further include a temporal score integration component 1020 configured to combine recency indicators, rolling window evaluations, cohort behavior metrics, and predictive scores into a unified follow-up opportunity score. Integration can be performed using weighted combinations, rule-based aggregation, or other configurable scoring techniques.

In non-limiting embodiments, temporal score integration component 1020 can apply weighting schemes that emphasize recency while incorporating cohort similarity and predictive likelihood. The integration logic can also reference outputs of hot opportunity classification system 900 of FIG. 9 to avoid overlap or duplication between hot opportunities and follow-up opportunities.

The components of follow-up opportunity classification system 1000 can operate in a staged evaluation pipeline while supporting parallel execution across multiple candidate opportunities using distributed processing frameworks described with respect to the data layer in FIG. 3. This architecture enables timely classification in high-volume environments with frequent transactional updates.

The output of follow-up opportunity classification system 1000 can include a classified opportunity object comprising at least a follow-up designation, one or more temporal metrics, associated cohort context, and a follow-up score suitable for downstream gating and delivery processing.

In an exemplary operation, recency evaluation component 1005 can calculate elapsed time since quote creation, rolling window analysis component 1010 can confirm occurrence within a recent evaluation window, cohort behavior analysis component 1015 can determine alignment with prior successful follow-ups, and temporal score integration component 1020 can produce a follow-up score indicating suitability for immediate outreach.

Follow-up opportunity classification system 1000 can operate across multiple opportunity types, including quotes, renewals, orders, or service interactions, and can be applied uniformly across different product lines, commercial models, or industries.

Governance mechanisms described in FIG. 4 can apply to follow-up opportunity classification system 1000, including role-based access control, authorization enforcement, and audit logging of follow-up classifications and underlying temporal metrics.

In some embodiments, follow-up opportunity classification system 1000 can include suppression logic configured to prevent repeated classification of the same opportunity after engagement has occurred, referencing engagement history or outcome data stored in one or more PDSes.

Temporal windows, decay functions, weighting schemes, and cohort definitions can be configurable through administrative or customization interfaces, allowing optimization based on historical conversion performance and operational preferences.

Accordingly, FIG. 10 illustrates a follow-up opportunity classification system 1000 that can identify time-sensitive opportunities based on recency and cohort-aware temporal analysis, enabling the R-IDA to prioritize timely engagement before opportunity relevance diminishes.

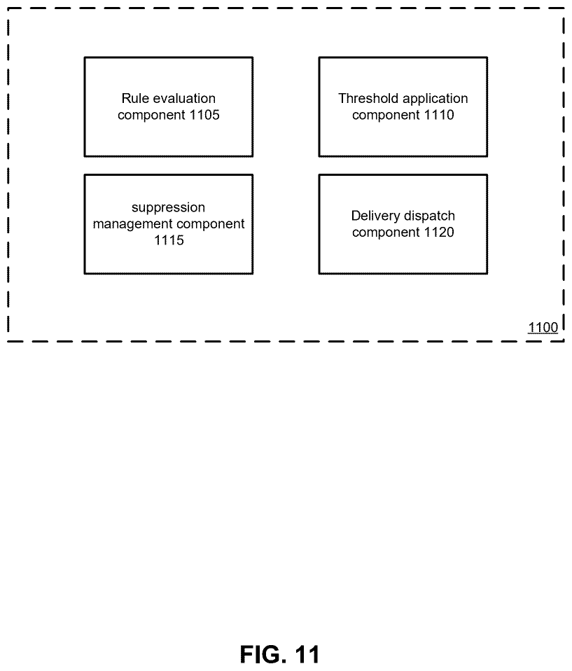

FIG. 11 illustrates a gating and delivery system 1100 configured to evaluate classified revenue opportunities against one or more gating criteria and to selectively emit or suppress such opportunities prior to delivery to downstream engagement interfaces. Gating and delivery system 1100 can operate as a control and dissemination layer within the revenue intelligent digital assistant (R-IDA) architecture of FIG. 5 and can receive classified opportunities from hot opportunity classification system 900 of FIG. 9 and follow-up opportunity classification system 1000 of FIG. 10.

Gating and delivery system 1100 can be operatively coupled to the data engine layer described in FIG. 3, enabling execution of configurable business logic through one or more pluggable processing engines. System 1100 can further interface with the federated data processing layer to retrieve real-time or near-real-time data from the plurality of purposive datastores (PDSes) for use in gating decisions.

Gating and delivery system 1100 can include a rule evaluation component 1105 configured to assess each classified opportunity against a plurality of gating rules. The gating rules can include, without limitation, confidence thresholds derived from predictive scores generated in FIG. 7, projected margin or revenue impact thresholds, inventory availability or available-to-promise conditions, vendor authorization or line-card eligibility, and temporal eligibility conditions associated with renewal windows or recency constraints.

Rule evaluation component 1105 can apply gating rules in parallel using distributed processing, and can distinguish between mandatory gating conditions and advisory gating conditions. In some embodiments, failure of a mandatory gating condition can result in suppression of the opportunity, while failure of an advisory condition can result in emission with an associated warning or reduced priority designation.

Gating and delivery system 1100 can further include a threshold application component 1110 configured to compare opportunity attributes and scores against numeric limits or rule parameters stored in one or more configuration datastores. Threshold application component 1110 can apply conditional logic to determine whether an opportunity satisfies required criteria for emission, and can generate structured decision outcomes indicating pass, fail, or conditional pass states.

Gating and delivery system 1100 can include a suppression management component 1115 configured to handle opportunities that fail one or more gating criteria. Suppression management component 1115 can record suppression reasons, suppress duplicate or substantially similar opportunities within defined time windows, and reference historical opportunity and engagement records stored in the PDSes to avoid repeated emission of non-actionable signals.

In some embodiments, suppression management component 1115 can apply cohort-aware suppression logic, preventing emission of follow-up opportunities where similar opportunities have recently been acted upon within the same customer, account, or cohort context.

Gating and delivery system 1100 can further include a delivery dispatch component 1120 configured to route emitted opportunities to one or more downstream engagement interfaces. The engagement interfaces can include sales dashboards, partner portals, customer-facing applications, or mobile interfaces, as described with respect to FIG. 4.

Delivery dispatch component 1120 can transmit opportunities using one or more delivery mechanisms, including application programming interfaces, message queues, event topics, or publish-subscribe channels. Delivered payloads can include opportunity identifiers, classification labels, scores, contextual attributes, recommended actions, and explanatory metadata.

Delivery dispatch component 1120 can incorporate reliability mechanisms including acknowledgement tracking, retry logic, and failure handling to ensure consistent delivery in the presence of transient network or system errors.

The components of gating and delivery system 1100 can operate in a staged pipeline while supporting parallel rule evaluation and delivery preparation, enabling low-latency processing in high-volume opportunity environments.

The output of gating and delivery system 1100 can include a filtered and delivered set of revenue opportunities that satisfy configured gating criteria, as well as suppressed opportunity records retained for audit, analytics, or feedback purposes.

In an exemplary operation, a hot opportunity classified in FIG. 9 can be evaluated by rule evaluation component 1105 for confidence and margin thresholds, threshold application component 1110 can verify satisfaction of numeric criteria, suppression management component 1115 can confirm absence of recent duplicate emissions, and delivery dispatch component 1120 can transmit the opportunity to a mobile sales interface.

Governance mechanisms described in FIG. 4 can apply to gating and delivery system 1100, including role-based access control over rule configuration, authorization checks for opportunity delivery, and audit logging of gating decisions and delivery outcomes.

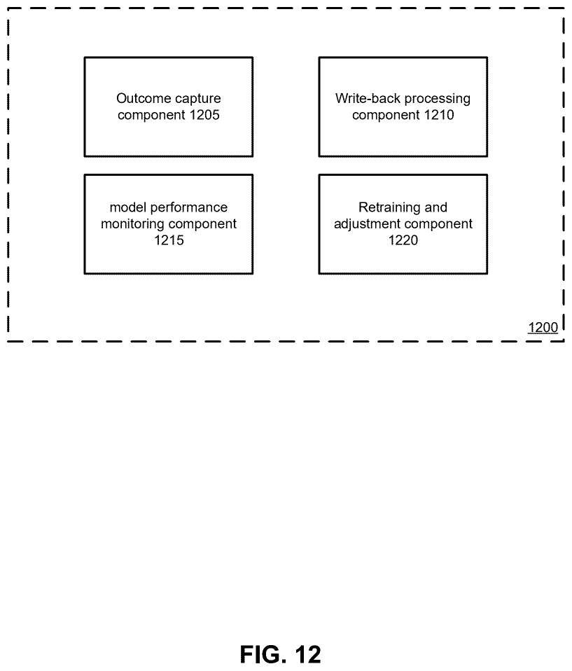

In some embodiments, gating and delivery system 1100 can support post-emission suppression or withdrawal of opportunities based on subsequent events, such as customer engagement, order placement, or updated inventory conditions, with such updates propagated through the feedback mechanisms described in FIG. 12.

Additional gating rules, including risk-based assessments, compliance checks, or market condition constraints, can be incorporated through the pluggable engines of the data engine layer without modification to the core architecture.

Gating rules, thresholds, suppression parameters, and delivery routing configurations can be adjustable through administrative or customization interfaces, allowing tuning based on observed performance and operational objectives.

Accordingly, FIG. 11 illustrates a gating and delivery system 1100 that ensures only qualified, actionable revenue opportunities are emitted and delivered, providing controlled transition from predictive intelligence to operational engagement within the R-IDA architecture.

FIG. 12 illustrates a feedback and refinement system 1200 configured to capture outcomes associated with delivered revenue opportunities and to feed such outcomes back into the revenue intelligent digital assistant (R-IDA) architecture for continuous improvement. Feedback and refinement system 1200 can operate as a closed-loop learning component within the architecture of FIG. 5, enabling refinement of attribute derivation as described in FIG. 6, predictive scoring as described in FIG. 7, and opportunity generation as described in FIG. 8.

Feedback and refinement system 1200 can be operatively coupled to the gating and delivery system 1100 of FIG. 11 and to the engagement interfaces described in FIG. 4. Through these interfaces, system 1200 can receive outcome data associated with emitted opportunities, including engagement results, transaction outcomes, and post-engagement metrics generated after delivery.

Feedback and refinement system 1200 can include an outcome capture component 1205 configured to collect and normalize outcome data associated with delivered opportunities. Outcome data can include, without limitation, win or loss indicators, realized revenue or margin values, engagement timestamps, disposition codes, and qualitative notes captured through sales or partner interfaces.

Outcome capture component 1205 can standardize captured outcome data using schemas aligned with the transformation and harmonization processes described with respect to FIG. 1. Both structured outcome indicators and unstructured engagement annotations can be normalized to enable consistent downstream processing and analysis.

Feedback and refinement system 1200 can further include a write-back processing component 1210 configured to propagate captured outcome data back into the real-time data mesh (RTDM) and associated purposive datastores (PDSes). Write-back processing component 1210 can update historical behavior datastores, order history datastores, quote outcome records, or other domain-specific PDSes to reflect observed engagement results.

The write-back processing component 1210 can utilize the integration and data distribution mechanisms described in FIG. 3 to ensure that outcome updates are harmonized, versioned, and made available for federated queries. Written-back outcome data can thereby influence subsequent attribute derivation cycles by updating revenue-related attributes derived in FIG. 6.

Feedback and refinement system 1200 can include a model performance monitoring component 1215 configured to evaluate predictive model performance by comparing predicted outputs generated in FIG. 7 against actual outcomes captured through component 1205. Performance evaluation can include calculation of error metrics, classification metrics, ranking metrics, or distributional comparisons over time.

In some embodiments, model performance monitoring component 1215 can detect performance drift by identifying deviations between predicted and observed outcomes that exceed configurable thresholds. Drift detection can account for changes in customer behavior, market conditions, product mix, or data quality affecting model accuracy.

Feedback and refinement system 1200 can further include a retraining and adjustment component 1220 configured to initiate refinement of one or more predictive models within the AI factory of FIG. 7. Retraining and adjustment can occur on a scheduled basis, in response to detected drift, or upon accumulation of sufficient new labeled outcome data.

Retraining and adjustment component 1220 can ingest updated training datasets from the PDSes via the federated data processing layer, retrain base models, adjust ensemble blending weights, or recalibrate scoring thresholds. In some embodiments, retraining workflows can include validation and rollback mechanisms to preserve prior model versions if updated models fail to meet performance criteria.

The components of feedback and refinement system 1200 can operate in an event-driven manner, with triggers originating from outcome updates, engagement completions, or periodic evaluation schedules. Asynchronous processing can be used to avoid disruption of real-time opportunity generation and delivery.

The output of feedback and refinement system 1200 can include updated predictive models, revised blending parameters, and enriched PDS records, enabling subsequent iterations of attribute derivation, scoring, and opportunity generation to reflect observed outcomes.

In an exemplary operation, an opportunity delivered through FIG. 11 can result in a completed transaction with a recorded margin. Outcome capture component 1205 can log the result, write-back processing component 1210 can update historical datastores, model performance monitoring component 1215 can evaluate prediction accuracy, and retraining and adjustment component 1220 can refine one or more models to better predict similar future opportunities.

Feedback and refinement system 1200 can apply uniformly across different opportunity types, including hot opportunities, follow-up opportunities, renewals, or other proactive engagement scenarios, and can operate independently of specific product categories or industries.

Governance mechanisms described in FIG. 4 can apply to feedback and refinement system 1200, including role-based access control for outcome data, authorization for retraining operations, and audit logging of write-back and model update activities.

In some embodiments, feedback and refinement system 1200 can support outcome-based suppression logic, preventing re-emission of opportunities that have repeatedly failed or resulted in negative outcomes within defined temporal windows.

Monitoring thresholds, retraining cadences, validation criteria, and rollback policies can be configurable through administrative or customization interfaces, enabling tuning based on observed system performance and operational objectives.

Accordingly, FIG. 12 illustrates a feedback and refinement system 1200 that closes the learning loop of the R-IDA architecture, enabling continuous improvement of predictive accuracy and opportunity quality through systematic incorporation of real-world engagement outcomes.

It should be understood that the operations shown in the exemplary methods are not exhaustive and that other operations can be performed as well before, after, or between any of the illustrated operations. In some embodiments of the present disclosure, the operations can be performed in a different order and/or vary.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system for generating proactive revenue opportunities within a distribution ecosystem, comprising:
a real-time data mesh (RTDM) module configured to monitor a plurality of transactional systems for real-time data changes using change data capture (CDC), wherein the CDC comprises at least one of log-based capture, trigger-based capture, or polling-based capture, and to capture and process the data changes;
a transformation module configured to transform the captured data into a standardized format via schema adaptation, data normalization, and enrichment processes;
a storage layer comprising a plurality of purposive datastores (PDSes) dynamically provisioned within a Global Data Lake based on at least one of data classification, access frequency, or computational workload, the storage layer configured to allocate the transformed data;
a federated data processing layer configured to integrate the transformed data and enable parallel query execution across the plurality of PDSes; and
a revenue intelligent digital assistant (R-IDA) decision engine configured to derive, from data stored in the plurality of PDSes, a plurality of revenue-related attributes associated with customers, products, quotes, orders, subscriptions, or renewals, to process the plurality of revenue-related attributes using one or more predictive scoring models to generate revenue opportunity scores, and to generate, based on the revenue opportunity scores, proactive revenue opportunities for delivery to at least one downstream engagement interface.

2. The system of claim 1, wherein the plurality of transactional systems comprise one or more enterprise resource planning systems, quoting systems, pricing systems, ordering systems, subscription management systems, or billing systems.

3. The system of claim 1, wherein the plurality of PDSes comprise domain-specific datastores corresponding to pricing data, quoting data, customer behavior data, order history data, renewal data, or vendor data.

4. The system of claim 1, wherein deriving the plurality of revenue-related attributes comprises aggregating attributes including historical quote behavior, open quote status, order conversion behavior, customer segmentation data, temporal recency data, seasonality, top vendors, customer size, and product or SKU traction data across multiple PDSes.

5. The system of claim 1, wherein the one or more predictive scoring models comprise an ensemble of models executed in parallel.

6. The system of claim 5, wherein the ensemble of models comprises at least a propensity model for conversion likelihood, a margin uplift model, or a renewal prediction model.

7. The system of claim 1, wherein generating the proactive revenue opportunities comprises identifying opportunities prior to receipt of a customer-initiated request, using real-time data from the federated data processing layer.

8. The system of claim 1, wherein the proactive revenue opportunities comprise hot opportunities identified based on observed traction across multiple customers, partners, or channels within a defined time window, calculated using a standardized traction metric relative to a baseline.

9. The system of claim 1, wherein the proactive revenue opportunities comprise time-sensitive follow-up opportunities identified based on recency of captured quote, order, or renewal events within a rolling window.

10. The system of claim 1, wherein the R-IDA decision engine is further configured to apply one or more gating rules to suppress or emit a proactive revenue opportunity based on one or more of a confidence threshold, a margin threshold, a vendor authorization condition, or a timing condition.

11. The system of claim 1, wherein the downstream engagement interface comprises a sales dashboard, a partner interface, a customer interface, or a mobile interface, and delivery occurs via API endpoints or message topics.

12. The system of claim 1, wherein outcomes associated with the proactive revenue opportunities are written back to the RTDM for model refinement including retraining.

13. A computer-implemented method for generating proactive revenue opportunities within a distribution ecosystem, the method comprising:
monitoring, by a real-time data mesh (RTDM), a plurality of transactional systems for real-time data changes using change data capture (CDC), wherein the CDC comprises at least one of log-based capture, trigger-based capture, or polling-based capture;
capturing and processing the data changes using the CDC of the RTDM;
transforming the captured data into a standardized format via schema adaptation, data normalization, and enrichment processes;
allocating the transformed data into a distributed storage framework comprising a plurality of purposive datastores (PDSes) dynamically provisioned within a Global Data Lake based on at least one of data classification, access frequency, or computational workload;
integrating the transformed data into a federated data processing layer configured to enable parallel query execution across the plurality of PDSes;
deriving, by a revenue intelligent digital assistant (R-IDA), a plurality of revenue-related attributes from data stored in the plurality of PDSes;
processing the plurality of revenue-related attributes using one or more predictive scoring models to generate revenue opportunity scores; and
generating proactive revenue opportunities based on the revenue opportunity scores.

14. The method of claim 13, wherein deriving the plurality of revenue-related attributes comprises joining data across multiple PDSes using shared identifiers corresponding to customers, products, quotes, orders, or subscriptions, with fallback imputation for missing values.

15. The method of claim 13, wherein processing the plurality of revenue-related attributes comprises combining outputs of a plurality of predictive scoring models into a composite score using weighted blending.

16. The method of claim 13, further comprising ranking the proactive revenue opportunities based on at least one of predicted conversion likelihood, predicted revenue impact, engagement urgency, or market trends derived from the PDSes.

17. The method of claim 13, further comprising classifying the proactive revenue opportunities into hot opportunities and follow-up opportunities based on cohort behavior, temporal characteristics, or traction metrics calculated in real-time.

18. The method of claim 13, further comprising delivering the proactive revenue opportunities to at least one downstream engagement interface via APIs, with error handling and retry mechanisms.

19. A non-transitory computer-readable medium storing instructions that, when executed by a processor, cause performance of a method comprising:
monitoring transactional systems using change data capture (CDC) within a real-time data mesh (RTDM), wherein the CDC comprises at least one of log-based capture, trigger-based capture, or polling-based capture;
transforming captured data changes into a standardized format via schema adaptation, data normalization, and enrichment;
storing the transformed data in a plurality of purposive datastores (PDSes) dynamically provisioned within a Global Data Lake;
integrating the stored data into a federated data processing layer for parallel query execution;
deriving revenue-related attributes from data in the plurality of PDSes;
processing the revenue-related attributes using one or more predictive scoring models; and
generating proactive revenue opportunities prior to customer-initiated engagement.

20. The non-transitory computer-readable medium of claim 19, wherein the method further comprises applying governance rules including role-based access control and audit logging to the revenue opportunities, and the system is configurable for deployment across heterogeneous enterprise environments.
